(19) United States
(12) Patent Application Publication
(10) Pub. No.: US 2010/0079705 A1
(43) Pub. Date: Apr. 1, 2010

(54) SUBSTRATE FOR LIQUID CRYSTAL DISPLAY DEVICE

(75) Inventors: Masao NAKAJIMA, Minami-ashigara-shi (JP); Akira Imakuni, Odawara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/570,652

(22) Filed: Sep. 30, 2009

(30) Foreign Application Priority Data
Sep. 30, 2008 (JP) 2008-253392

(51) Int. Cl. G02F 1/1347; G02F 1/13363; C08G 73/10

(52) U.S. Cl. 349/75; 349/117; 528/322

(57) ABSTRACT

A substrate for liquid crystal display device comprising a layer having irregular differences in level and a smoothing layer provided directly on the layer having irregular differences in level, wherein the thickness of the smoothing layer is greater than the irregular differences in level, and the in-plane retardation of the layer inclined of 40° with the retardation axis as the axis of rotation is 5 to 150 nm, which enables to reduce the number of steps in manufacturing, is provided by the present invention.

### CROSS-REFERENCE TO RELATED APPLICATIONS

This application claims benefit of priority under 35 USC 119 to Japanese Patent Application No. 2008-253392 filed on Sep. 30, 2008, the disclosure of which is expressly incorporated by reference herein in its entirety.

### TECHNICAL FIELD

The present invention relates to a substrate for liquid crystal display device. More particularly, the present invention relates to a substrate for liquid crystal display device comprising, on an uneven layer, a smoothing layer functioning as an optically anisotropic layer, or functioning as an alignment layer and an optically anisotropic layer.

### BACKGROUND ART

A CRT (cathode ray tube) has been mainly employed in various display devices used for office automation (OA) equipment such as a word processor, a notebook-sized personal computer and a personal computer monitor, mobile phone terminal and television set. In recent years, a liquid crystal display device has more widely been used in place of a CRT, because of its thinness, lightweight and low power consumption. A liquid crystal display device usually comprises a liquid crystal cell and polarizing plates. The polarizing plate usually has protective films and a polarizing film, and is obtained typically by dying a polarizing film composed of a polyvinyl alcohol film with iodine, stretching the film, and laminating the film with the protective films on both surfaces. A transmissive liquid crystal display device usually comprises polarizing plates on both sides of a liquid crystal cell, and occasionally comprises one or more optical compensation films. A reflective liquid crystal display device usually comprises a reflector plate, a liquid crystal cell, one or more optical compensation films, and a polarizing plate in this order. A liquid crystal cell comprises liquid-crystalline molecules, two substrates encapsulating the liquid-crystalline molecules, and electrode layers applying voltage to the liquid-crystalline molecules. The liquid crystal cell switches ON and OFF displays depending on variation in orientation state of the liquid-crystalline molecules, and is applicable both to transmission type and reflective type, of which display modes ever proposed include TN (twisted nematic), IPS (in-plane switching), OCB (optically compensatory bend) and VA (vertically aligned) ECB (electrically controlled birefringence), and STN (super twisted nematic). Color and contrast displayed by the conventional liquid crystal display device, however, vary depending on the viewing angle. Therefore, it cannot be said that the viewing angle characteristics of the liquid crystal display device is superior to those of the CRT.

In order to improve the viewing angle characteristics, retardation films for viewing-angle optical compensation have been used. There have been proposed various LCDs, employing a mode and an optical compensation film having an appropriate optical property for the mode, excellent in contrast characteristics without dependency on viewing angles. An OCB, VA or IPS modes are known as a wide-viewing mode, and LCDs employing such a mode can give a good contrast characteristic in all around view, and, then, become widely used as a home screen such as TV. Further, in recent years, a wide screen of over 30 inches has been also proposed.

VA mode, which affords the same good display characteristics as TN mode when viewed from the front, but also achieves wide viewing angle characteristics through the application of an optical compensation film to compensate for the viewing angle, has now become the most widespread LCD mode. In VA mode, wide viewing angle characteristics are achieved through the use of a uniaxially oriented retardation plate having positive refractive index anisotropy in the direction of the film surface (a positive a-plate) and a negative uniaxially oriented retardation plate having an optical axis in a direction perpendicular to the film surface (negative c-plate) (see Japanese Unexamined Patent Publication (KOKAI) Heisei No. 10-153802 (pp. 12 and 13, FIG. 54), the disclosure of which is expressly incorporated by reference herein in its entirety).

Since a retardation plate is bonded with adhesive at a prescribed angle with respect to a polarizing plate for use, the contrast ends up decreasing due to reflection at the boundary with the adhesive, which has a lower refractive index than the polarizing plate or retardation film. Further, the dimensions of the retardation film vary with temperature and humidity, resulting in the problem of LCD corner blurring. Thus, the method of providing an optically anisotropic layer in the form of a retardation plate along with a color filter or the like in a liquid-crystal cell has been reported in recent years (for example, Japanese Patent Application 2007-233376, the disclosure of which is expressly incorporated by reference herein in its entirety).

When an optically anisotropic layer is provided within a liquid-crystal cell by such a method, it becomes necessary to provide multiple layers, such as a smoothing layer for leveling irregularities resulting from the black matrix of the color filter and the like, and an alignment layer required to fabricate an optically anisotropic layer employing polymerizable liquid-crystalline compounds, on the substrate of the liquid crystal display device. This increases the number of steps in manufacturing.

Japanese Unexamined patent Publication (KOKAI) No. 2008-033244, the disclosure of which is expressly incorporated by reference herein in its entirety, discloses a substrate for liquid crystal display device in which the function of an orientation film having a liquid-crystal orientation property is imparted to a protective layer for leveling the color filter. By imparting multiple functions to a single layer, it is possible to reduce the number of steps in the manufacturing of a substrate for liquid crystal display device. Further, Japanese Unexamined Patent Publication (KOKAI) No. 2004-226945, the disclosure of which is expressly incorporated by reference herein in its entirety, describes a birefringent film serving as both an optically anisotropic layer and an alignment layer.

### SUMMARY OF THE INVENTION

The object of the present invention is to provide a substrate for liquid crystal display device having an optically anisotropic layer that enables to reduce the number of steps in manufacturing.

The present inventors conducted intensive research, and found as a result that it was possible to manufacture a layer that functioned to level the irregular shape of the layer beneath it, functioned as an optically anisotropic layer, and functioned as an alignment layer and an optically anisotropic layer. The present invention was devised on the basis of this finding. The present invention thus provides [1] to [18] as follows:

[1] A substrate for liquid crystal display device comprising a layer having irregular differences in level and a smoothing layer provided directly on the layer having irregular differences in level, wherein the thickness of the smoothing layer is greater than the irregular differences in level, and the in-plane retardation of the layer inclined of 40° with the retardation axis as the axis of rotation is 5 to 150 nm.
[2] The substrate for liquid crystal display device according to [1], wherein a second optically anisotropic layer is provided directly on an orientation-processed surface of the smoothing layer.
[3] The substrate for liquid crystal display device according to [2], wherein the orientation process is selected from the group consisting of rubbing, optical orientation, extension, and contraction.
[4] The substrate for liquid crystal display device according to [2] or [3], wherein the second optically anisotropic layer is an optically anisotropic layer having a positive uniaxial or diaxial property with an optical axis in an in-plane direction of the substrate.
[5] The substrate for liquid crystal display device according to any one of [2] to [4], wherein the in-plane retardation of the second optically anisotropic layer is 40 to 550 nm.
[6] The substrate for liquid crystal display device according to any one of [2] to [5], wherein the second optically anisotropic layer is a layer that is formed by applying and drying a solution comprising a liquid-crystalline compound having at least one reactive group to form a liquid-crystal phase, followed by heating or irradiation with light.
[7] The substrate for liquid crystal display device according to [6], wherein the liquid-crystalline compound is a rod-like liquid-crystalline compound.
[8] The substrate for liquid crystal display device according to any one of [1] to [7], wherein the pitch of the irregularities is 10-fold or greater the irregular differences in level.
[9] The substrate for liquid crystal display device according to any one of [1] to [8], wherein the layer having irregular differences in level is a color filter layer or a layer in which TFT is formed.
[10] The substrate for liquid crystal display device according to any one of [1] to [9], wherein the smoothing layer is formed by applying and drying a solution comprising a compound having at least one reactive group, followed by heating or irradiation with light.
[11] The substrate for liquid crystal display device according to [10], wherein the compound having a reactive group comprises a least one polymerizable group selected from the group consisting of an acetylene group, maleimide group, nadiimide group, benzoxazine group, vinyl group, epoxy group, cyanate group, and isocyanate group.
[12] The substrate for liquid crystal display device according to any one of [1] to [11], wherein the smoothing layer is a layer comprising at least one selected from the group consisting of polyimide, polyisoimide, polyesterimide, polyetherimide, polyamide-imide, polyamide acid, polyamide acid ester, polyamide, polyamine, polythioamide, polyurethane, polyurea, and polyazomethine.
[13] The substrate for liquid crystal display device according to any one of [1] to [12], wherein the absorbance at 400 nm wavelength of the smoothing layer is 0.2 or lower.
[14] The substrate for liquid crystal display device according to anyone of [1] to [13], wherein the smoothing layer has negative uniaxial optical anisotropy with an optical axis that is substantially normal to the surface.
[15] A liquid-crystal display device comprising the substrate for liquid crystal display device of any one of [1] to [14].
[16] The liquid-crystal display device of [15], wherein the orientation mode of the liquid-crystal display device is VA mode.
[17] A composition for producing a smoothing layer of a substrate for liquid crystal display device, comprising a copolymer having the repeating unit represented by general formula (1) and the repeating unit represented by general formula (2) as follows:

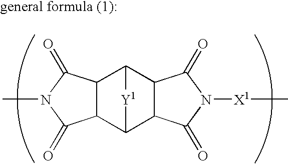

in general formula (1), Y¹ represents methylene group, ethylene group, or ethenylene group, and X¹ represents a divalent linking group represented by general formula (3) below;

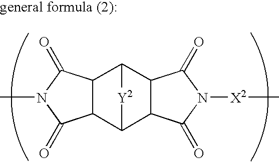

in general formula (2), Y² represents methylene group, ethylene group, or ethenylene group, and X² represents a divalent linking group represented by general formula (4) below;

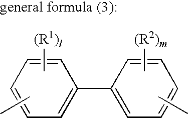

in general formula (3), each of R¹ and R² independently represents a group selected from the group consisting of a halogen atom, a substituted or unsubstituted alkyl group, a substituted or unsubstituted alkoxy group, and a substituted or unsubstituted aryl group, and each of l and m independently represents an integer of 0 to 4;

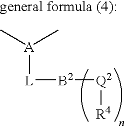

in general formula (4), A represents an unsubstituted or optionally substituted cyclic or acyclic hydrocarbon group, with A not comprising a partial structure in which three or more aromatic rings are directly linked by a single carbon atom; B² represents a substituted or unsubstituted aryl group or a heteroaryl group; L represents a divalent linking group; Q² represents a reactive group (such as the above-described reactive groups); R⁴ represents hydrogen atom, unsubstituted or optionally substituted cyclic or acyclic hydrocarbon group; and n represents an integer of 0 or greater.
[18] The composition according to [17], wherein the terminals of the copolymer are sealed with a compound represented by general formula (5) as follows:

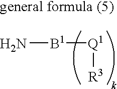

in general formula (5), B¹ represents a substituted or unsubstituted aryl group or a heteroaryl group; Q¹ represents a reactive group (such as the above-described reactive groups); R³ represents hydrogen atom or an unsubstituted or optionally substituted cyclic or acyclic hydrocarbon group; and k represents an integer of 0 or greater.

### BRIEF DESCRIPTION OF THE DRAWINGS

FIG. 1 is a plot of the results of measurement of the irregular differences in level on a color filter substrate employed in Examples.

FIG. 2 is a plot of the results of measurement of the irregular differences in level on the surfaces of the substrate for liquid crystal display devices of Example 1 and Comparative Example 1.

### EMBODIMENT OF THE INVENTION

Paragraphs below will detail the present invention.

In the specification, ranges indicated with “to” mean ranges including the numerical values before and after “to” as the minimum and maximum values.

The in-plane retardation Re at the wavelength of λ nm is measured by means of KOBRA 21ADH or WR manufactured by Oji Scientific Instruments while applying a λ nm wavelength light in the normal line direction of the film. Re(θ) represents in-plane retardation measured by inclining the sample by 0° using the slow axis as the axis of rotation. Re(θ) is measured by means of KOBRA 21ADH or WR manufactured by Oji Scientific Instruments based on the parallel Nicol method while applying a λ nm wavelength light and inclining the sample by 0° using the slow axis as the axis of rotation. In this specification, λ is 611±5 nm, 545±5 nm and 435±5 nm for R, G and B, respectively, and denotes 550±5 nm if no specific description is made on color.

It is to be noted that, regarding angles, the term “substantially” in the context of this specification means that a tolerance of less than ±5° with respect to the precise angles can be allowed. Difference from the precise angles is preferably less than 4°, and more preferably less than 3°. It is also to be noted that, regarding retardation values, the term “substantially” in the context of this specification means that a tolerance of less than ±5% with respect to the precise values can be allowed. It is also to be noted that the term “The Re value is not substantially zero” in the context of this specification means that the Re value is not less than 5 nm. The measurement wavelength for refractive indexes is a visible light wavelength, unless otherwise specifically noted. It is also to be noted that the term “visible light” in the context of this specification means light of a wavelength falling within the range from 400 to 700 nm.

In the substrate for liquid crystal display device of the present invention, a layer functioning as both a smoothing layer and an optically anisotropic layer is provided. This layer can also function as an alignment layer. Such a layer is desirably provided on a layer having irregularities, such as a color filter layer.

Unless specifically stated otherwise, the terms “substrate for liquid crystal display device” and “substrate” are not used interchangeably in the present specification.

The materials, manufacturing method, and the like of the substrate for liquid crystal display device of the present invention will be described in detail below. However, the present invention is not limited to these embodiments. Additional embodiments can be implemented by referencing the description given below and conventionally known methods. The present invention is not limited to the embodiments set forth below.

### [Substrate]

The substrate used for the process of producing the liquid crystal display device of the present invention is not particularly limited as long as it is transparent. The substrate may be any of known glasses such as soda glass sheet having a silicon oxide film formed on the surface thereof, low-expansion glass, non-alkali glass, or silica glass; or a transparent substrate formed of polymer. In the substrate for liquid crystal display device, the substrate is preferred to have heat-resistance, because production of the substrate for liquid crystal display device includes processes at high-temperature more than 180° C. for baking of color filter or alignment layer. As such substrate having heat-resistance, glass sheet, polyimide, polyether sulfone, heat-resisting polycarbonate, or polyethylene naphthalate is preferred. Glass sheet is particularly preferred in from the viewpoint of price, transparency, and heat-resistance. The substrate can be improved in the adhesiveness with the adhesive layer for transfer by being preliminarily subjected to a coupling treatment. The coupling treatment is preferably carried out by using the method described in Japanese Unexamined Patent Publication (KOKAI) No. 2000-39033. The thickness of the substrate is preferably 100 to 1200 μm in general, most preferably 300 to 1000 μm, although being not specifically limited.

### [The Layer Having Irregular Differences in Level]

In the present specification, the “layer having irregular differences in level” refers to a layer having irregularities at a layer boundary due to a change in structure, layer thickness, or the like. Since this term can be suitably employed for layers having periodic irregularities in the present invention, specific examples will be set forth further below. Examples of layers having periodic irregularities include color filter layers and TFT layers. That is, the layer having irregular differences in level includes a layer with a black matrix or electrode on the surface thereof, thus having overall irregular differences in level that include these items. There is no specific limitation to a color filter layer or TFT layer. Any commercially available layer may be employed, and a layer manufactured by any conventionally known method may be employed.

### [The Irregular Differences in Level and the Pitch of the Irregularities]

The term “irregular differences in level” refers to the average value of the differences in level of one periodic section of irregularity in the periodic irregularities among the irregularities present on the surface of a layer having irregular differences in level. When forming an optically anisotropic layer on a layer having irregular differences in level of 0.3 micrometer or more, there is a high probability that orientation defects will occur, resulting in the problem of a reduction of image quality due to color nonuniformity on the display screen. Thus, the smaller the irregular differences in level, the better.

Further, the pitch of the irregularities refers to the average value of the length of one periodic section of irregularities. That is, saying that the pitch of the irregularities is N-fold or more the irregular difference in level is the same as saying that (the average value of the length of one periodic section of irregularities)/(the average difference in level of one periodic section of irregularities)≧N. In the present specification, the larger the pitch of the irregularities of the layer having irregular differences in level, the fewer the sources of orientation defects per unit area, making it possible to decrease the reduction in the picture quality of the display. A pitch of 10-fold or greater the irregular difference in level is preferred, 20-fold or greater is more preferred, and 40-fold or greater is of even greater preference.

### [The Smoothing Layer]

From the perspective of leveling the irregular surface, the thickness of the smoothing layer in the present invention is preferably greater than the irregular differences in level, more preferably 2.0 micrometers or more greater than the irregular differences in level. Further, the smoothing layer is preferably transparent, since it will be used for display applications. The degree of transparence is not specifically limited other than that enough light pass through to be visible. However, a total light transmittance of 50 percent or greater is preferred, and 70 percent or greater is more preferred. Further, the absorbance at a wavelength of 400 nm is preferably 0.2 or lower, more preferably 0.1 or lower.

### [The First Optically Anisotropic Layer]

The smoothing layer doubles as an optically anisotropic layer (the first optically anisotropic layer). As an optically anisotropic layer, it is not specifically limited. However, it is preferably a negative c-plate with an optical axis in the direction of thickness. Further, the in-plane retardation when the sample is tilted 40° with the slow axis as the axis of rotation is preferably 5 to 100 nm, more preferably 10 to 50 nm.

The first optically anisotropic layer also has the effect of preventing the leakage of light due to orientation defects caused by irregularities in the underlayer produced when the second optically anisotropic layer is directly applied without the first optically anisotropic layer. The first optically anisotropic layer widens the scope of selection in the optical design, materials, and the like of the second optically anisotropic layer that is laminated as the upper layer.

### [The Alignment Layer]

The smoothing layer can also double as an alignment layer.

The term “alignment layer” refers to a layer that is formed so that the orientation of the optically anisotropic layer will not be defective. Although it is necessary to determine whether or not to employ an orientation process based on the circumstances, it is generally preferable to have an orientation process. Possible orientation processing methods are rubbing, optical orientation, extension, and contraction. The use of a rubbing process, which is widely employed as a liquid-crystal orientation processing step for LCDs, is preferable. In the rubbing step, it suffices to effect processing that produces orientation by rubbing the surface of the layer in a certain direction with paper, gauze, felt, rubber, nylon, polyester fiber, or the like. Generally, this process can be implemented by several sessions of rubbing with cloth or the like in which bristles of fiber of uniform length and thickness have been evenly implanted.

### [The Composition for Forming the Smoothing Layer]

The composition for forming the smoothing layer is, for example, a composition comprising at least one member selected from the group consisting of polyamine, polyimide, polyisoimide, polyesterimide, polyetherimide, polyamide-imide, polyamide acid, polyamide acid ester, polyamide, polythioamide, polyurethane, polyurea, and polyazomethine; preferably a composition comprising at least one member selected from the group consisting of polyimide, polyisoimide, polyesterimide, polyetherimide, polyamide-imide, polyamide acid, polyamide acid ester, and polyamide; and more preferably a composition comprising at least one member selected from the group consisting of polyimide, polyisoimide, polyesterimide, polyetherimide, polyamide-imide, and polyamide acid. To impart resistance to solvent following formation of the smoothing layer, the smoothing layer is preferably formed by coating and drying a composition comprising a compound having at least one reactive group, followed by heating or irradiation with light. The reactive group is not specifically limited; acetylene, maleimide, nadiimide, benzoxazine, vinyl, epoxy, cyanate, and isocyanate groups are preferred, and an acetylene group is more preferred.

A copolymer having both the repeating unit represented by general formula (1) below and that represented by general formula (2) below is particularly preferable as the composition for forming the smoothing layer:

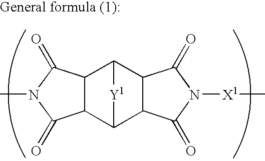

In general formula (1), Y¹ represents methylene group, ethylene group, or ethenylene group, preferably represents ethylene group or an ethenylene group, and more preferably represents ethylene group, and X¹ represents a divalent linking group represented by general formula (3) below.

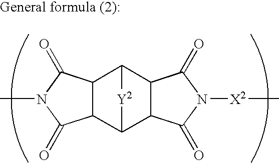

In general formula (2), Y² represents methylene group, ethylene group, or ethenylene group, preferably represents ethylene group or an ethenylene group, and more preferably represents ethylene group, and X² represents a divalent linking group represented by general formula (4) below.

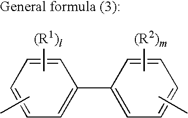

In general formula (3), each of R¹ and R² independently represents one member selected from the group consisting of a halogen atom, a substituted or unsubstituted alkyl group, a substituted or unsubstituted alkoxy group, and a substituted or unsubstituted aryl group.

Fluorine, chlorine, bromine, or iodine atom is preferred, and a fluorine or chlorine atom is more preferred as a halogen atom. An alkyl group having 1 to 8 carbon atoms, such as methyl group, ethyl group, propyl group, isopropyl group, or trifluoromethyl group is preferred, and methyl group, ethyl group, or trifluoromethyl group is more preferred as a substituted or unsubstituted alkyl group. An alkoxy group having 1 to 8 carbon atoms, such as ethoxy group, methoxy group or phenoxy group is preferred, and phenoxy group or a methoxy group is more preferred as a substituted or unsubstituted alkoxy group. A monocyclic or condensed polycyclic aromatic group having 6 to 14 carbon atoms, such as phenyl group, naphthyl group, or p-methoxyphenyl group, is preferred, and phenyl group is more preferred, as a substituted or unsubstituted aryl group. With respect to the linking group connecting two benzenes, R¹ and R² preferably occupy the ortho position; with respect to the linking group connecting two benzenes the group linking with the nitrogen atom preferably occupies the 3 and 4 positions, more preferably occupying the 4 position.

Each of l and m independently represents an integer of 0 to 4, preferably represents an integer of 1 to 4, more preferably represents an integer of 1 or 2, and further preferably represents 1.

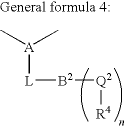

In general formula (4), A represents an unsubstituted or optionally substituted cyclic or acyclic hydrocarbon group. However, A does not include the case where three or more aromatic rings are directly linked through a single carbon atom. B² represents a substituted or unsubstituted aryl group or heteroaryl group. Either one or both of A and B² preferably represent benzene ring. L represents a divalent linking group, and preferably represents a single bond, —OCO—, —COO—, —NRCO—, —CONR—, —NRCOO—, —OCONR—, or —NRCONR—. Q² represents the aforementioned reactive group that may be identical to or different from, but is preferably identical to, Q¹. R⁴ represents hydrogen atom, an unsubstituted or optionally substituted cyclic or acyclic hydrocarbon group, preferably a hydrocarbon group. And n represents an integer of 0 or greater, and preferably represents 1.

A copolymer the terminals of which are sealed with a compound represented by general formula (5) below is preferably employed as the polymer for forming the smoothing layer.

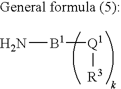

In general formula (5), B¹ represents a substituted or unsubstituted aryl group or heteroaryl group, with a benzene ring being preferable. Q¹ represents the aforementioned reactive group. R³ represents hydrogen atom, an unsubstituted or optionally substituted cyclic or acyclic hydrocarbon group, with hydrogen atom being preferable. And k represents an integer of 0 or greater, and preferably represents 1.

Specific preferred examples of the structure of general formula (1) are given below. However, the present invention is not limited to the following examples.

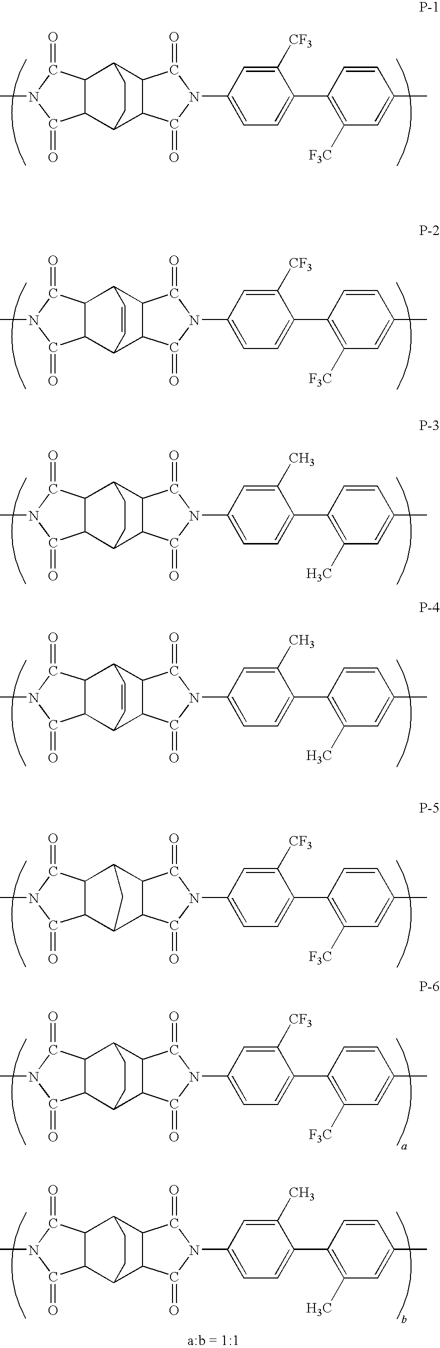

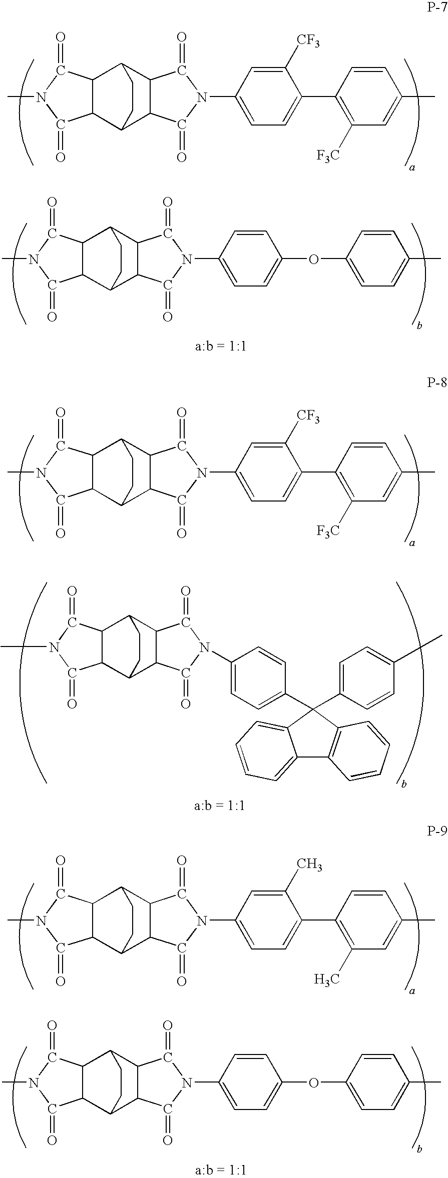

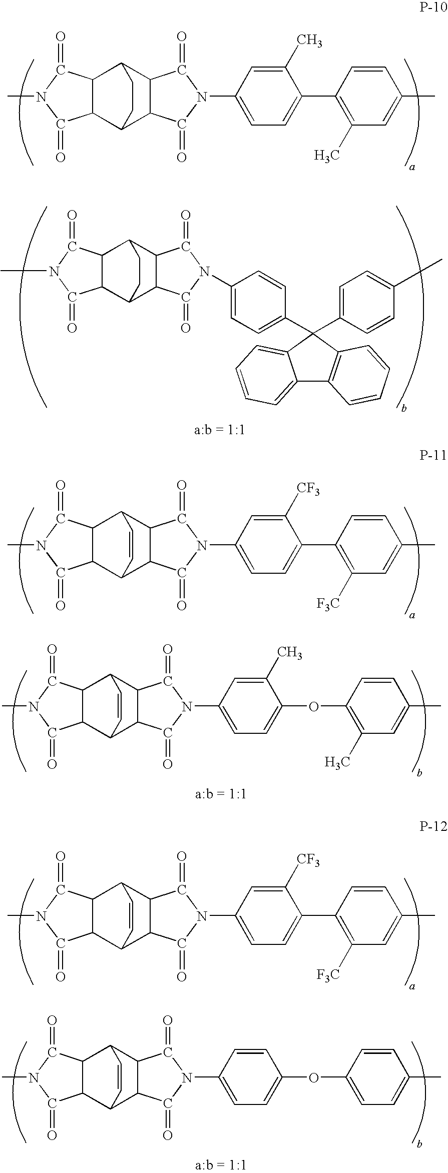

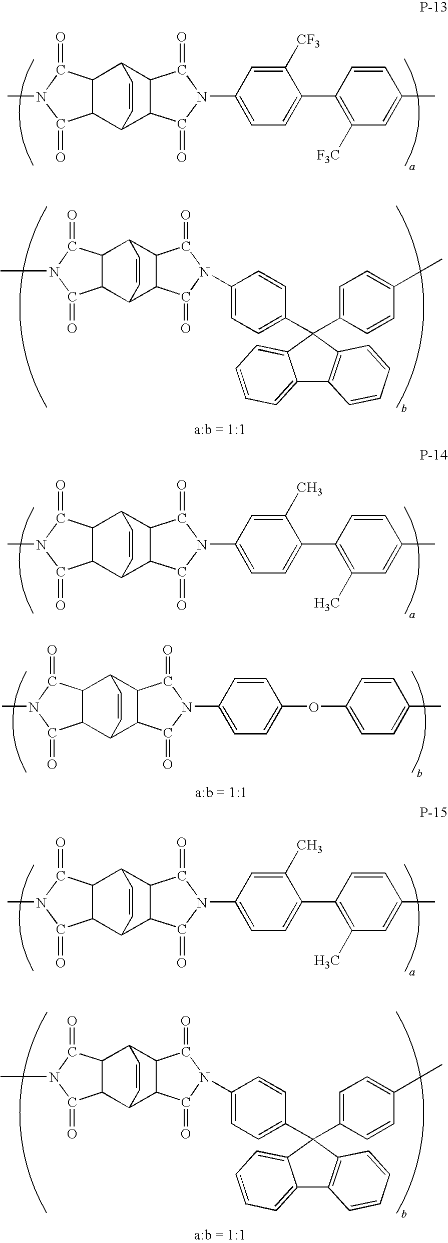

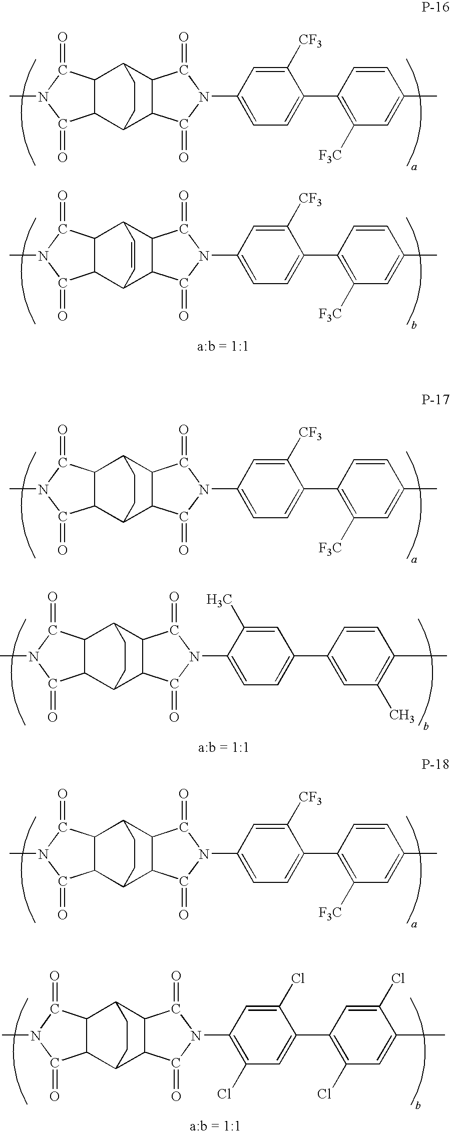

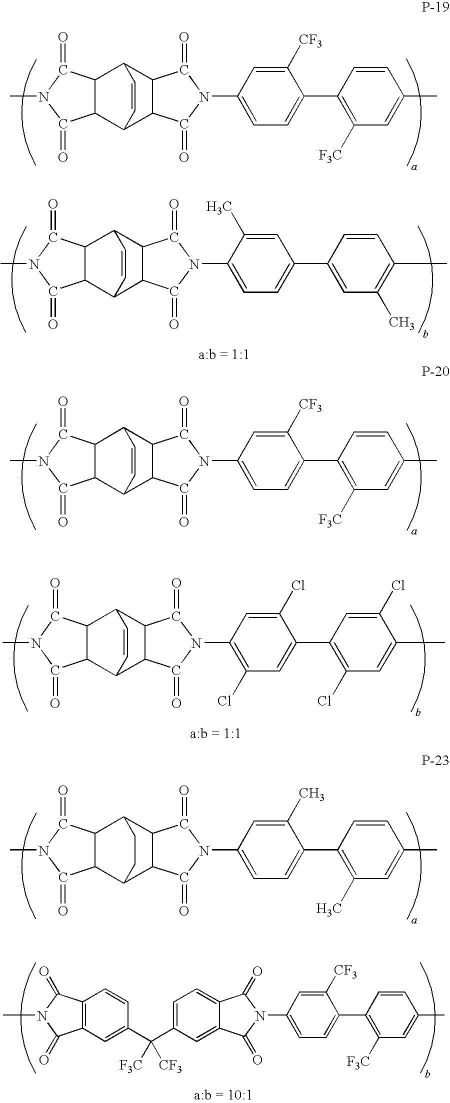

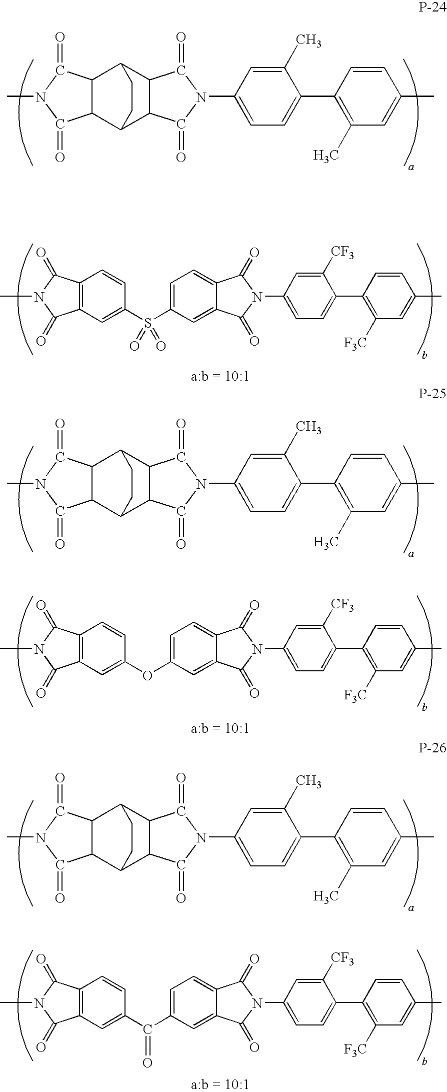

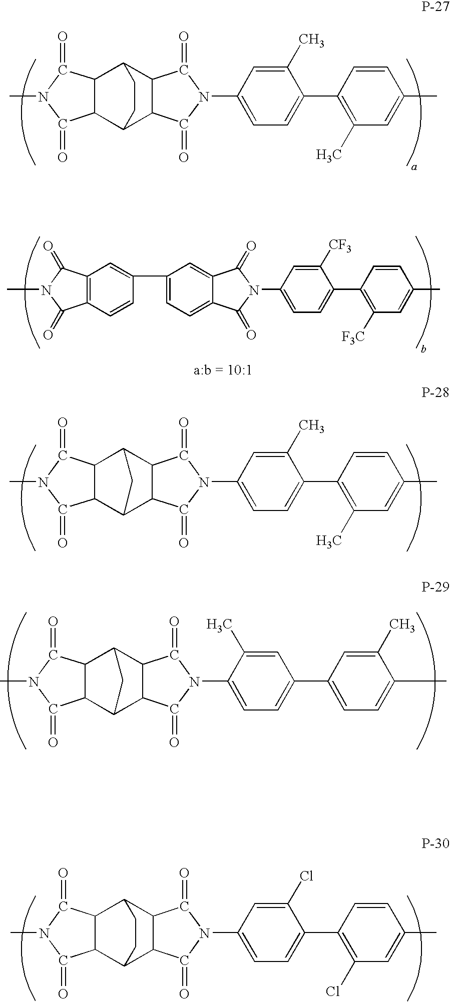

Specifically preferred examples of the partial structure without X² in general formula (2) are given below. However, the present invention is not limited the following examples.

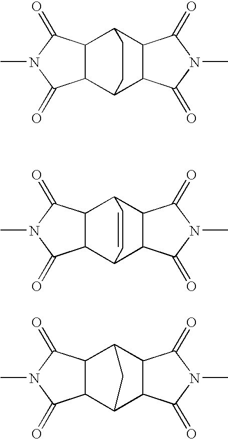

Specifically preferred examples of the structure of X² in general formula (2) are given below. However, the present invention is not limited thereto the following examples. Acetylene is a preferable example of the reactive group in all the specific examples indicated below. However, the corresponding reactive group may also be one of the other reactive groups indicated above.

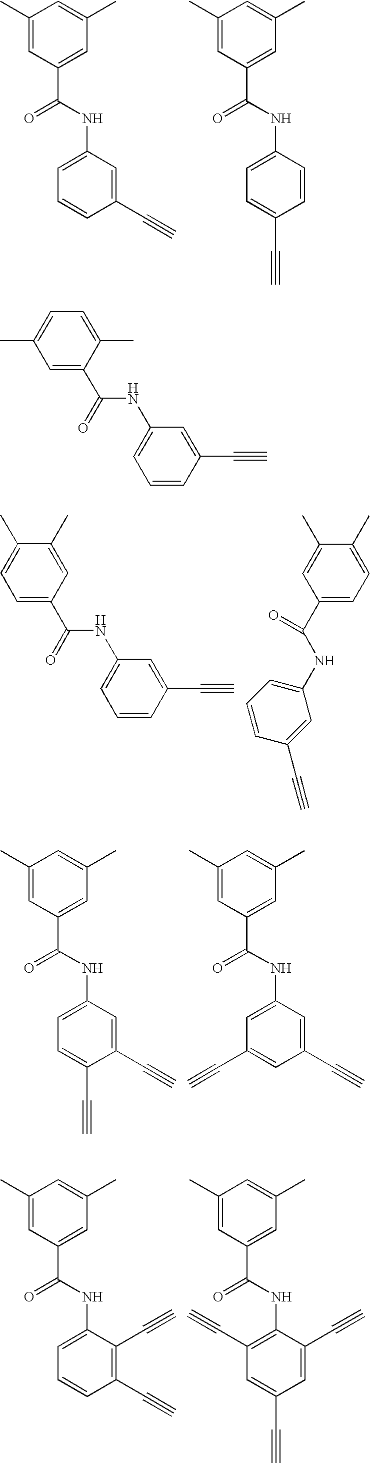

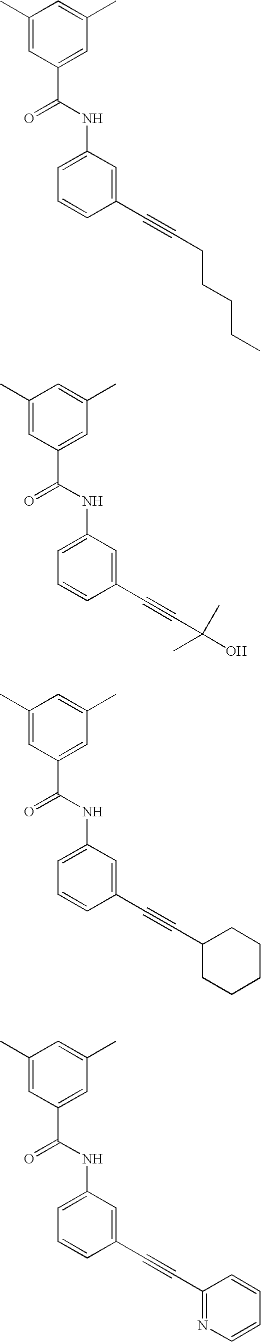

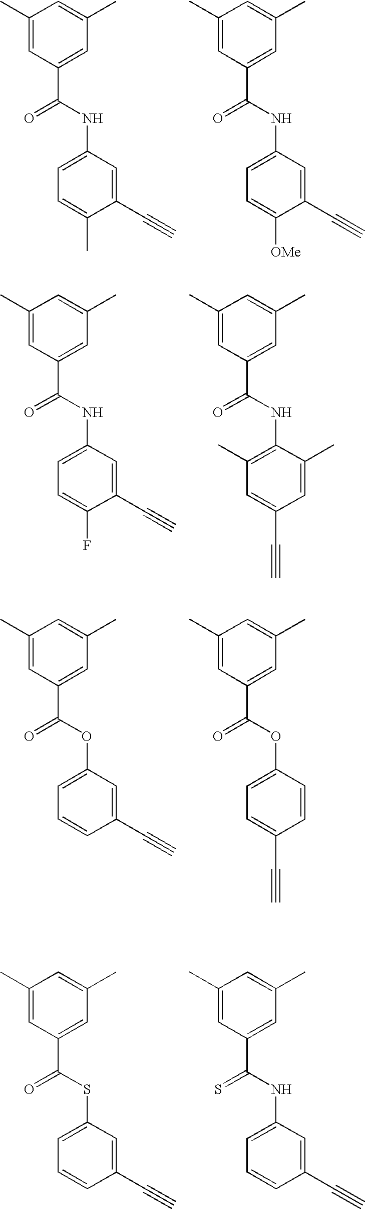

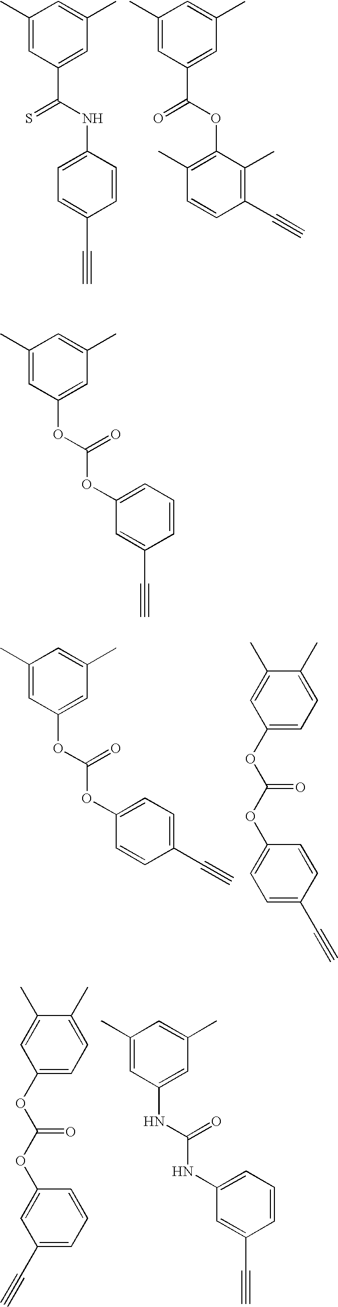

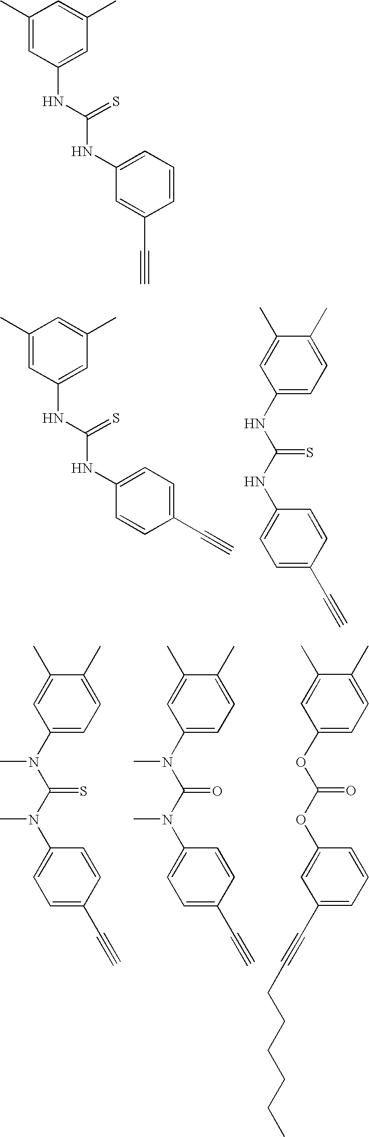

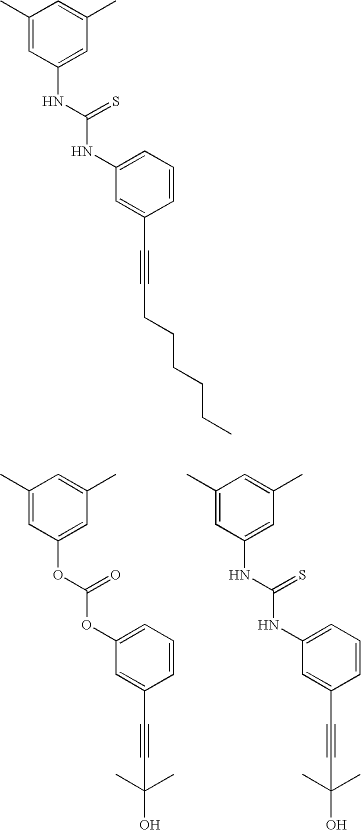

Specifically preferred examples of the structure of general formula (5) are given below. However, the present invention is not limited the following examples.

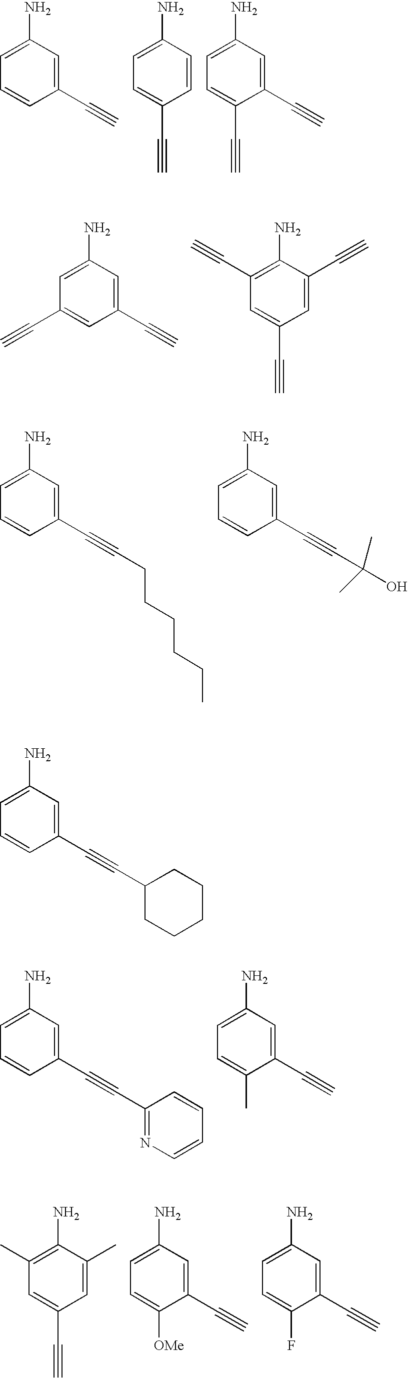

### [The Solvent of the Composition for Forming the Smoothing Layer]

The examples of solvents that can be employed in preparing the smoothing layer include acetone, methyl ethyl ketone, methyl isobutyl ketone, chloroform, dichloromethane, tetrahydrofuran, pyridine, benzene, hexane, 1,2-dimethoxyethane, N-methyl-2-pyrrolidone, N-methylcaprolactam, gamma-butyrolactone, ethyl cellosolve, butyl cellosolve, ethyl carbitol, butyl carbitol, ethylcarbitol acetate, propylene glycol monoacetate, propylene glycol diacetate, propylene glycol-1-monomethylether-2-acetate, propylene glycol-1-monoethylether-2-acetate, propylene glycol-n-butylether acetate, tripropylene glycol methylether acetate, 1,3-butanediol diacetate, dipropylene glycol-n-propylether acetate, dipropylene glycol mono-n-butyl ether acetate, diethylene glycol monobutyl ether acetate, propylene carbonate, dipropylene glycol monomethyl ether, dipropylene glycol mono-n-butyl ether, diethylene glycol monobutyl ether, cyclohexanone, cyclohexanol, 1-methoxy-2-propanol, 1-ethoxy-2-propanol, 1-butoxy-2-propanol, 1-phenoxy-2-propanol, 2-(2-ethoxypropoxy)propanol, ethylene glycol, dipropylene glycol, N,N-dimethylformamide, N,N-dimethylacetamide, dimethylsulfoxide, dimethylsulfone, hexamethylsulfoxide, methyl acetate, butyl acetate, ethyl lactate, methyl lactate, n-propyl lactate, n-butyl lactate, isoamyl lactate, and caprolactam. Two or more of these organic solvents may be combined for use.

### [The Second Optically Anisotropic Layer]

The second optically anisotropic layer may be provided on the smoothing layer. A composition comprising at least one liquid-crystalline compound is preferably prepared as a liquid-crystal phase and cured by being heated or irradiated with light (UV radiation or the like) to form an optically anisotropic layer. The second optically anisotropic layer can be formed by applying the above composition on the surface of the smoothing layer that has been orientation processed.

The second optically anisotropic layer functions both as a smoothing layer and as an optically anisotropic layer that compensates for the viewing angle of liquid crystal cells. Adequate viewing angle compensation capability may be achieved with the smoothing layer and the second optically anisotropic layer. The smoothing layer and the second optically anisotropic layer can also be further combined with other layers to satisfy the optical characteristics required to compensate for the viewing angle. The birefringence of the second optically anisotropic layer is not specifically limited. However, a positive uniaxial or biaxial optically anisotropic layer with an optical axis in an in-plane direction of the substrate is preferable. The second optically anisotropic layer is more preferably a positive a-plate. A uniaxial birefringent layer having an in-plane optical axis and in which the refractive index of the retardation axis is greater than that in the direction of thickness is called an “a-plate.” A positive a-plate can be realized, for example, by horizontally orienting rod-like liquid crystals.

### [Liquid-Crystalline Compound]

The liquid-crystalline compounds can generally be classified by molecular geometry into rod-like one and discotic one. Each category further includes low-molecular type and high-molecular type. The high-molecular type generally refers to that having a degree of polymerization of 100 or above (“Kobunshi Butsuri-Soten'i Dainamikusu (Polymer Physics-Phase Transition Dynamics), by Masao Doi, p. 2, published by Iwanami Shoten, Publishers, 1992). Either type of the liquid-crystalline molecule may be used in the present invention, wherein it is preferable to use a rod-like liquid-crystalline compound or a discotic liquid-crystalline compound. A mixture of two or more rod-like liquid-crystalline compound, a mixture of two or more discotic liquid-crystalline compound, or a mixture of a rod-like liquid-crystalline compound and a discotic liquid-crystalline compound may also be used. It is more preferable that the optically anisotropic layer is formed using a composition comprising the rod-like liquid-crystalline compound or the discotic liquid-crystalline compound, having a reactive group, because such compound can reduce temperature- and moisture-dependent changes, and it is still further preferable that at least one compound in the mixture has two or more reactive group in a single liquid-crystalline molecule. The liquid-crystalline composition may be a mixture of two or more compounds, wherein at least one of the compounds preferably has two or more reactive groups. The thickness of the optically anisotropic layer is preferably 0.1 to 20 μm, more preferably 0.5 to 10 μm, and further preferably 1 to 4 μm.

Examples of the rod-like liquid-crystalline compound include azomethine compounds, azoxy compounds, cyanobiphenyl compounds, cyanophenyl esters, benzoate esters, cyclohexanecarboxylic acid phenyl esters, cyanophenylcyclohexane compounds, cyano-substituted phenylpyrimidine compounds, alkoxy-substituted phenylpyrimidine compounds, phenyldioxane compounds, tolan compounds and alkenylcyclohexylbenzonitrile compounds. Not only the low-molecular-weight, liquid-crystalline compound as listed in the above, high-molecular-weight, liquid-crystalline compound may also be used. The high-molecular-weight rod-like liquid-crystalline compounds may be obtained by polymerizing low-molecular-weight rod-like liquid-crystalline compounds having at least one reactive group. Among such low-molecular-weight liquid-crystalline compounds, liquid-crystalline compounds represented by a formula (I) are preferred.

Q¹-L¹-A¹-L³-M-L⁴-A²-L²-Q² Formula (I)

In the formula, Q¹ and Q² respectively represent a reactive group. L¹, L², L³ and L⁴ respectively represent a single bond or a divalent linking group, and it is preferred that at least one of L³ and L⁴ represents —O— or —O—CO—O—. A¹ and A² respectively represent a C₂₋₂₀ spacer group. M represents a mesogen group.

In formula (I), Q¹ and Q² respectively represent a reactive group. The polymerization reaction of the reactive group is preferably addition polymerization (including ring opening polymerization) or condensation polymerization. In other words, the reactive group is preferably a functional group capable of addition polymerization reaction or condensation polymerization reaction. Examples of reactive groups are shown below.

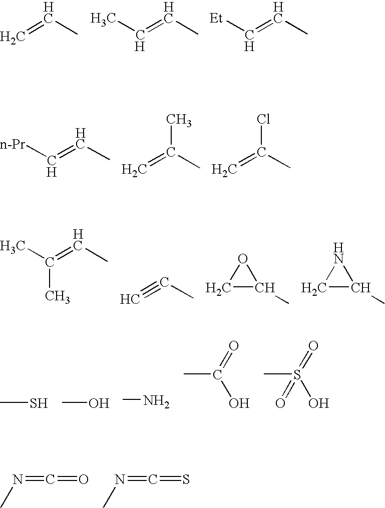

L¹, L², L³ and L⁴ independently represent a divalent linking group, and preferably represent a divalent linking group selected from the group consisting of —O—, —S—, —CO—, —NR²—, —CO—O—, —O—CO—O—, —CO—NR²—, —NR²—CO—, —O—CO—, —O—CO—NR²—, —NR²—CO—O— and —NR²—CO—NR²—. R² represents a C₁₋₇ alkyl group or a hydrogen atom. It is preferred that at least one of L³ and L⁴ represents —O— or —O—CO—O— (carbonate group). It is preferred that each of Q¹-L¹ and Q²-L²- is respectively CH₂═CH—CO—O—, CH₂═C(CH₃)—CO—O— or CH₂═C(Cl)—Co—O—CO—O—; and it is more preferred each is CH₂═CH—CO—O—.

In the formula, A¹ and A² preferably represent a C₂₋₂₀ spacer group. It is more preferred that they respectively represent C₂₋₁₂ aliphatic group, and much more preferred that they respectively represent a C₂₋₁₂ alkylene group. The spacer group is preferably selected from chain groups and may contain at least one unadjacent oxygen or sulfur atom. And the spacer group may have at least one substituent such as a halogen atom (fluorine, chlorine or bromine atom), cyano, methyl and ethyl.

Examples of the mesogen represented by M include any known mesogen groups. The mesogen groups represented by formula (II) are preferred.

—(—W¹-L⁵)ₙ-W²- Formula (II)

In the formula, W¹ and W² independently represent a divalent cyclic aliphatic group or a divalent hetero-cyclic group; and L⁵ represents a single bond or a linking group. Examples of the linking group represented by L⁵ include those exemplified as examples of L¹ to L⁴ in the formula (1) and —CH₂—O— and —O—CH₂—. In the formula, n is 1, 2 or 3.

Examples of W¹ and W² include 1,4-cyclohexanediyl, 1,4-phenylene, pyrimidine-2,5-diyl, pyridine-2,5-diyl, 1,3,4-thiazole-2,5-diyl, 1,3,4-oxadiazole-2,5-diyl, naphtalene-2,6-diyl, naphtalene-1,5-diyl, thiophen-2,5-diyl, pyridazine-3,6-diyl. 1,4-Cyclohexanediyl has cis-trans isomers stereoisomers. Any stereoisomers in a pure form, any mixtures of the stereoisomers may be used. However, the trans isomer is preferred. W¹ and W² may respectively have at least one substituent. Examples the substituent include a halogen atom such as a fluorine, chlorine, bromine or iodine atom; cyano; a C₁₋₁₀ alkyl group such as methyl, ethyl and propyl; a C₁₋₁₀ alkoxy group such as methoxy and ethoxy; a C₁₋₁₀ acyl group such as formyl and acetyl; a C₂₋₁₀ alkoxycarbonyl group such as methoxy carbonyl and ethoxy carbonyl; a C₂₋₁₀ acyloxy group such as acetyloxy and propionyloxy; nitro, trifluoromethyl and difluoromethyl.

Preferred examples of the basic skeleton of the mesogen group represented by the formula (II) include, but not to be limited to, these described below. The examples may have at least one substituent selected from the above.

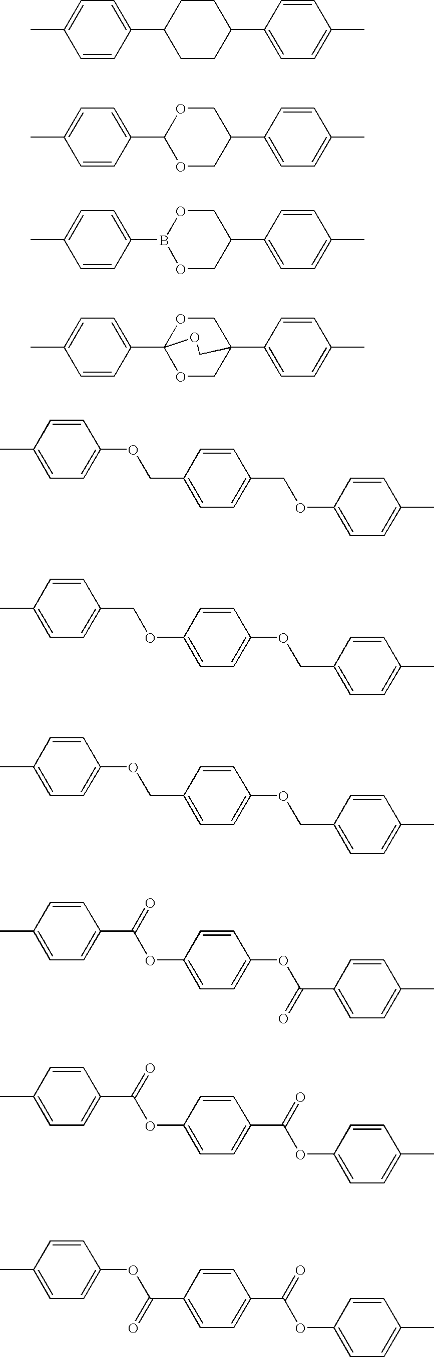

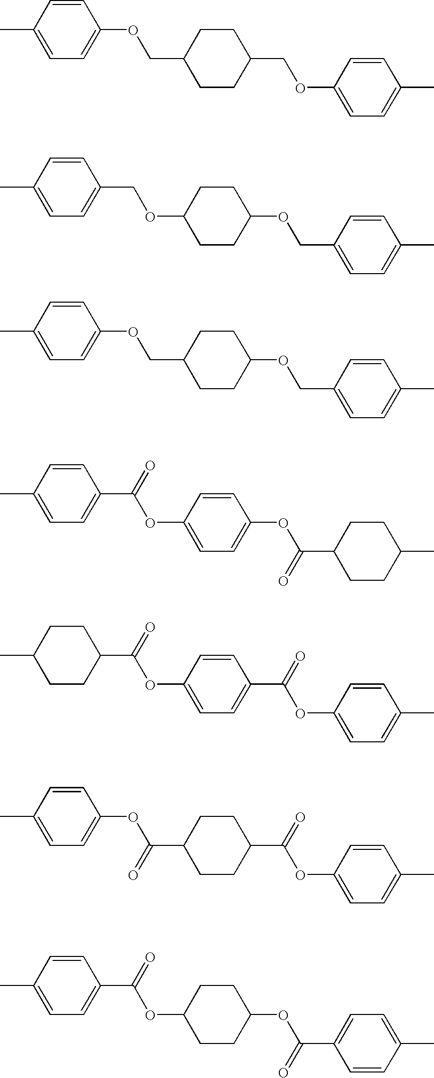

Examples the compound represented by the formula (1) include, but not to be limited to, these described below. The compounds represented by the formula (I) may be prepared according to a method described in a gazette of Tokkohyo No. hei 11-513019 or WO97/00600.

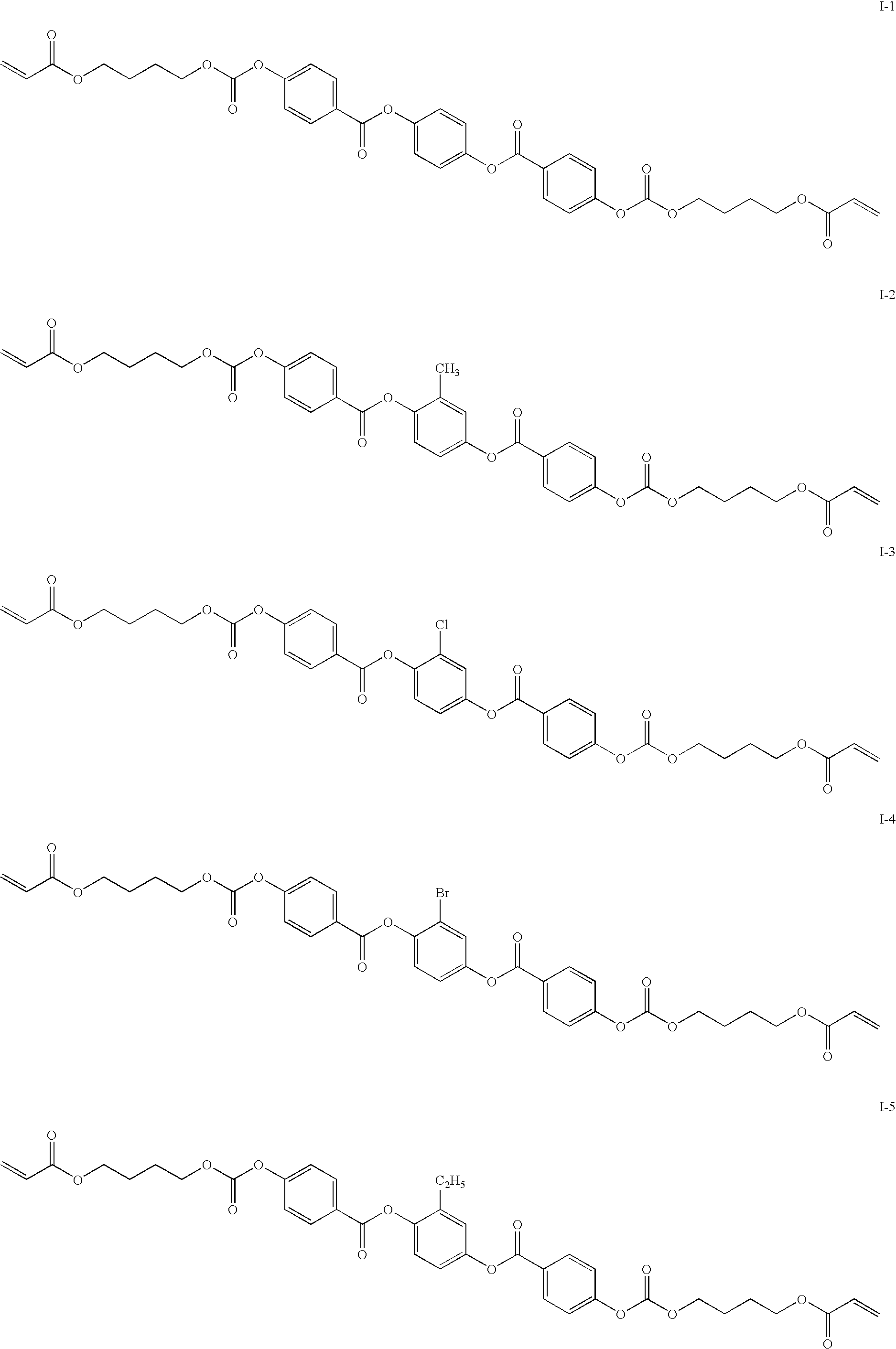

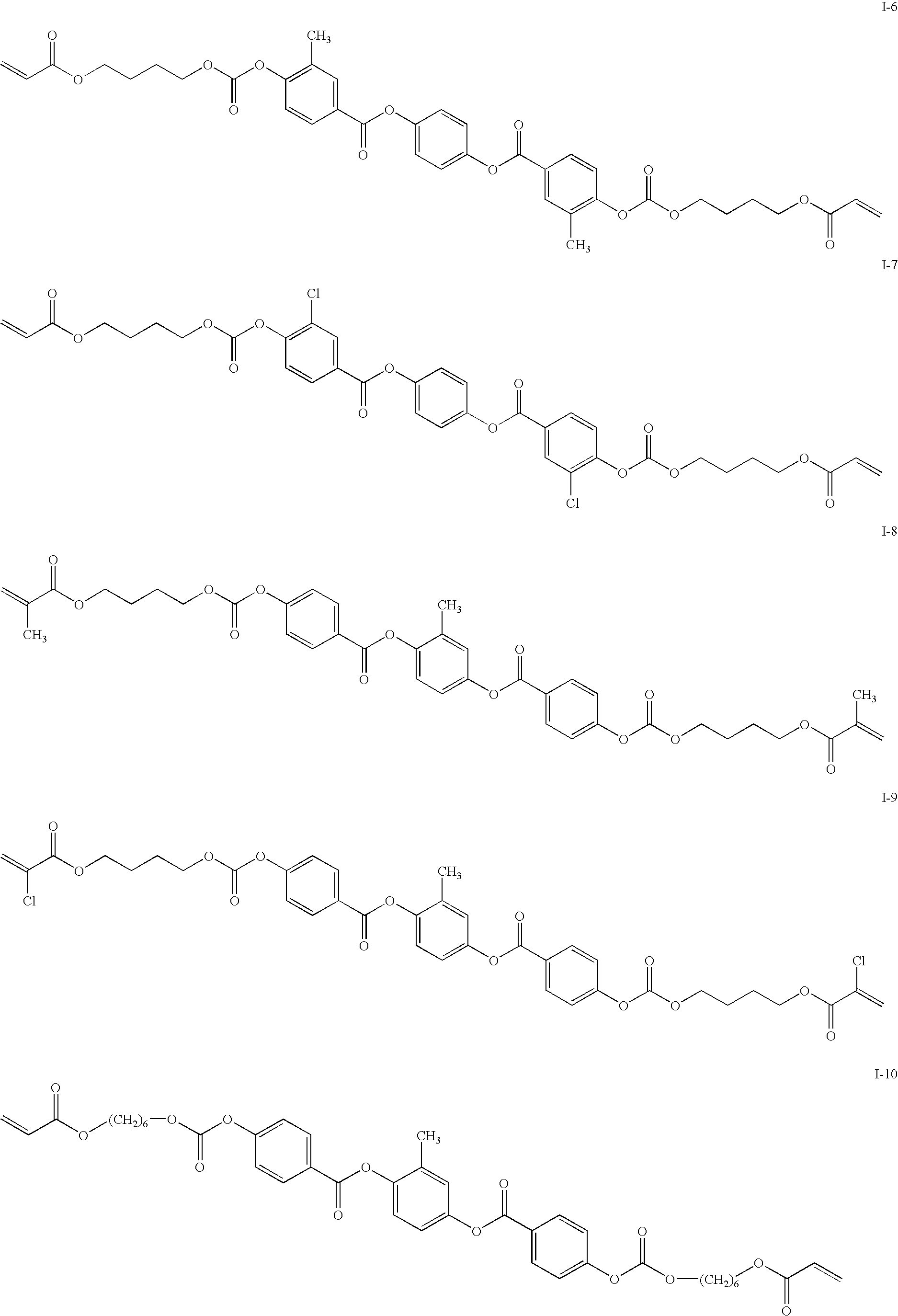

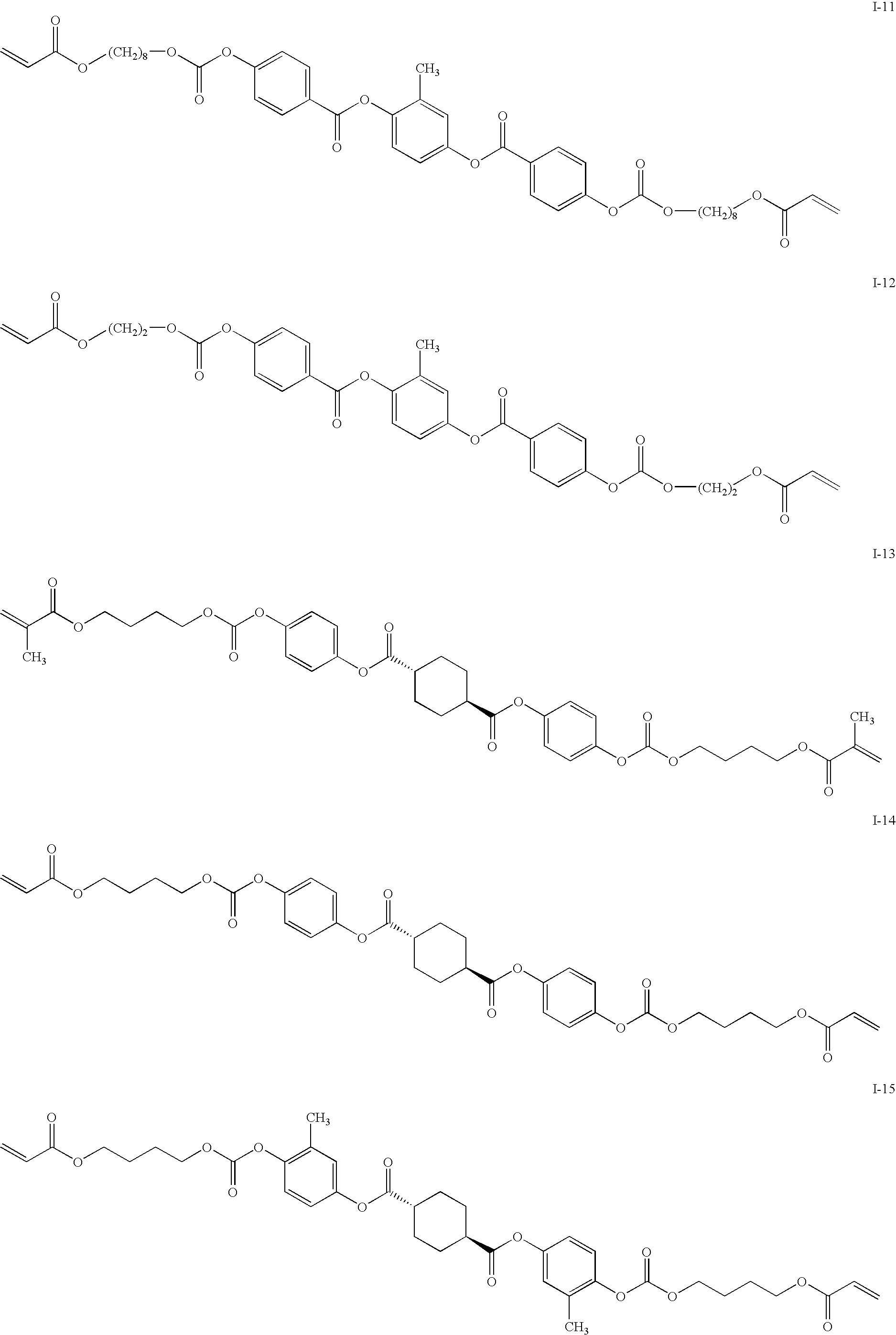

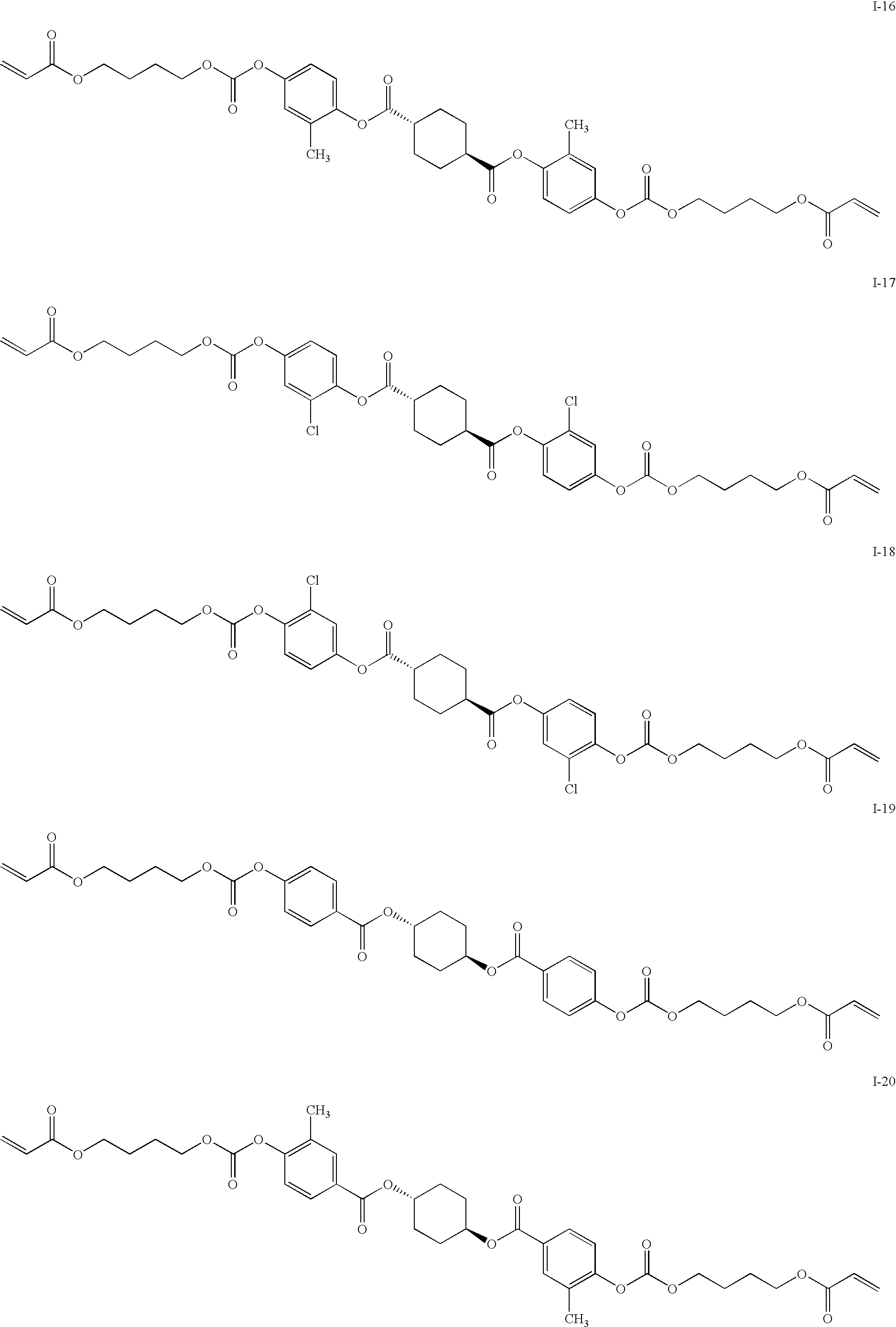

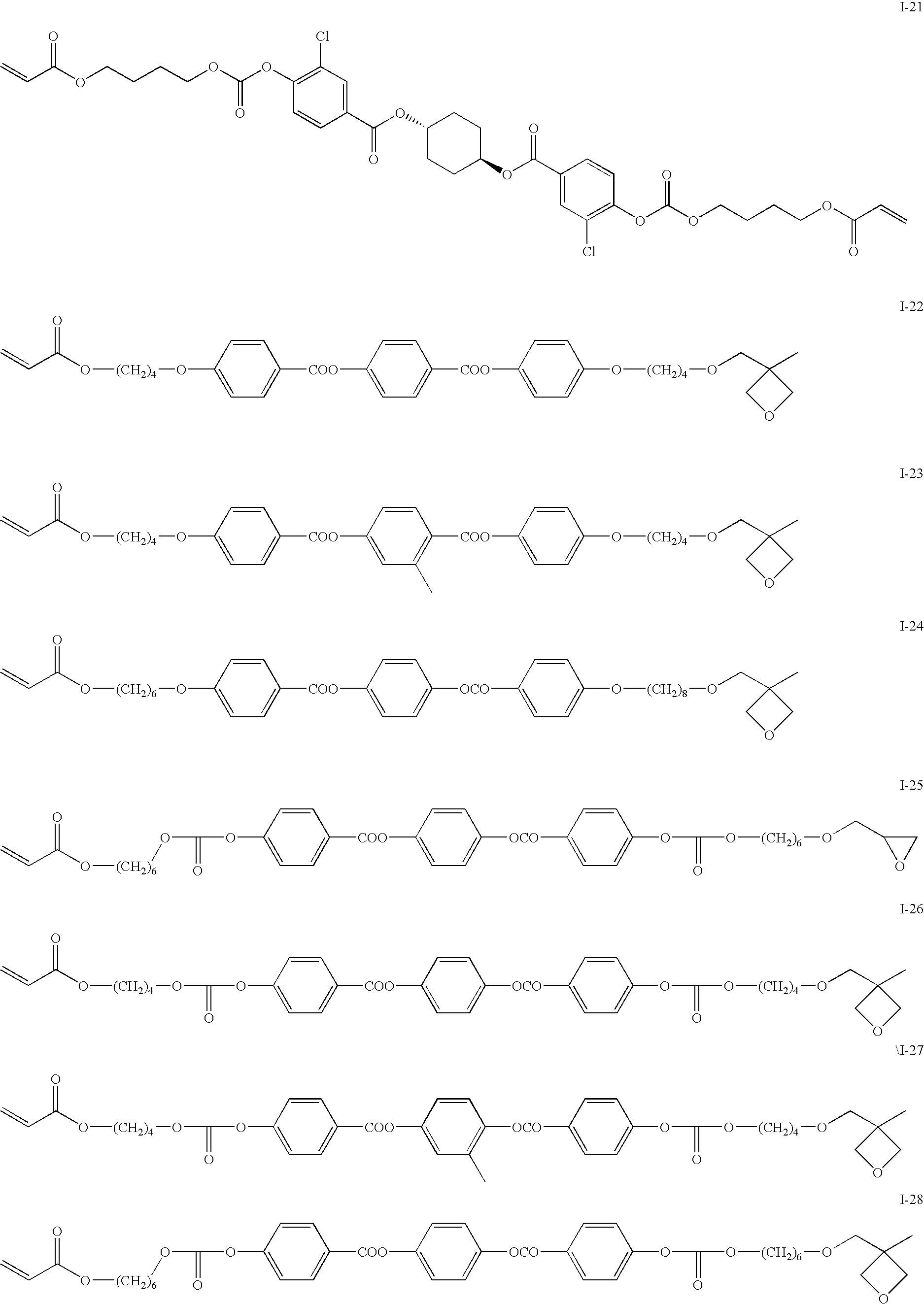

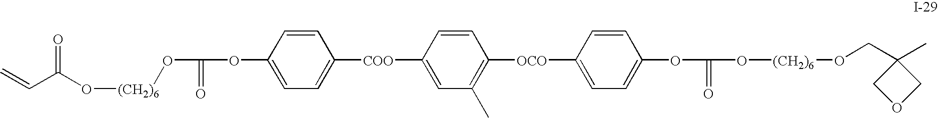

When a rod-like liquid-crystalline compound having a reactive group is used as the liquid-crystalline compound, the molecule may be fixed in any of horizontal, tilted, hybrid, and twisted orientations. In the specification, horizontal orientation means a state in which molecules are aligned with a tilt angle against a layer plane less than 10 degree.

As another embodiment of the present invention, discotic liquid-crystalline compounds can be used for the second optically anisotropic layer. The optically anisotropic layer is preferably a layer of liquid-crystalline discotic compounds of low molecular weight such as monomers, or a polymer layer obtained by polymerization (curing) of polymerizable liquid-crystalline discotic compounds. Examples of the discotic liquid-crystalline compound include benzene derivatives described in C. Destrade et al., Mol. Cryst., Vol. 171, p. 111 (1981); torxene derivatives described in C. Destrade et al., Mol. Cryst., Vol. 122, p. 141 (1985) and Physics Lett., A, Vol. 78, p. 82 (1990); cyclohexane derivatives described in B. Kohne et al., Angew. Chem., Vol. 96, p. 70 (1984); and azacrown-base or phenylacetylene-base macrocycles described in J. M. Lehn, J. Chem. Commun., p. 1794 (1985) and in J. Zhang et al., J. Am. Chem. Soc., Vol. 116, p. 2655 (1994). The above mentioned discotic (disk-like) compounds generally have a discotic core in a central portion and groups (L), such as linear alkyl or alkoxy groups or substituted banzoyloxy groups, which radiate from the core. Among them, there are compounds exhibiting liquid crystallinity, and such compounds are generally called as discotic liquid crystal. When such molecules are aligned uniformly, the aggregate of the aligned molecules may exhibit an optically negative uniaxial property. But the present invention is not limited to these descriptions.

In the specification, the term of “formed of a discotic compound” is used not only when finally comprising the discotic compound as a low-molecular weight compound, but also when finally comprising a high-molecular weight discotic compound, no longer exhibiting liquid crystallinity, formed by carrying out crosslinking reaction of the low-molecular weight discotic compound having at least one reactive group capable of thermal reaction or photo reaction under heating or under irradiation of light.

According to the present invention, it is preferred that the discotic liquid-crystalline compound is selected from the formula (III) below:

D(-L-P)ₙ Formula (III)

In the formula, D represents a discotic core, L represents a divalent linking group, P represents a polymerizable group, and n is an integer from 4 to 12.

Preferred examples of the discotic core (D), the divalent linking group (L) and the polymerizable group (P) are respectively (D1) to (D15), (L1) to (L25) and (P1) to (P18) described in Japanese Unexamined Patent Publication (Kokai) No. 2001-4837; and the descriptions in the publication regarding the discotic core (D), the divalent linking group (L) and the polymerizable group (P) may be preferably applicable to this embodiment.

Preferable examples of the above discotic compound include the compounds described in [0045] to [0055] of Japanese Unexamined Patent Publication (Kokai) No. 2007-121986.

When two or more optically anisotropic layers formed of the liquid-crystalline compositions are stacked, the combination of the liquid-crystalline compositions is not particularly limited, and the combination may be a stack formed of liquid-crystalline compositions all comprising discotic liquid-crystalline molecules, a stack formed of liquid-crystalline compositions all comprising rod-like liquid-crystalline molecules, or a stack formed of a layer comprising discotic liquid-crystalline molecules and a layer comprising rod-like liquid-crystalline molecules. Combination of orientation state of the individual layers also is not particularly limited, allowing stacking of the optically anisotropic layers having the same orientation status, or stacking of the optically anisotropic layer having different orientation states.

### [Application of the Composition Containing Liquid-Crystalline Compound]

The second optically anisotropic layer may be formed by applying a coating liquid, containing a liquid-crystalline compound and, if necessary, a polymerization initiator as described below or other additives, to the orientation-processed surface of the smoothing layer. The solvent used for preparing the coating liquid is preferably an organic solvent. Examples of organic solvents include acetone, methyl ethyl ketone, methyl isobutyl ketone, chloroform, dichloromethane, tetrahydrofuran, pyridine, benzene, hexane, 1,2-dimethoxyethane, N-methyl-2-pyrrolidone, cyclohexanone, cyclohexanol, propyleneglycol-1-monomethylether-2-acetate, propyleneglycol-1-monoethylether-2-acetate, 1,3-butanediol-acetate, N,N-dimethyl formamide, dimethyl sulfoxide, methyl acetate, butyl acetate, ethyl lactate, methyl lactate, caprolactam. Two or more organic solvents may be used in combination.

### [Fixing of Liquid-Crystalline Molecules in an Alignment State]

The liquid-crystalline molecules in an alignment state are preferably fixed without disordering the state. Fixing is preferably carried out by the polymerization reaction of the reactive groups contained in the liquid-crystalline molecules. The polymerization reaction includes thermal polymerization reaction using a thermal polymerization initiator and photo-polymerization reaction using a photo-polymerization initiator. Photo-polymerization reaction is preferred. Examples of photo-polymerization initiators include alpha-carbonyl compounds (described in U.S. Pat. Nos. 2,367,661 and 2,367,670), acyloin ethers (described in U.S. Pat. No. 2,448,828), alpha-hydrocarbon-substituted aromatic acyloin compounds (described in U.S. Pat. No. 2,722,512), polynuclear quinone compounds (described in U.S. Pat. Nos. 3,046,127 and 2,951,758), combinations of triarylimidazole dimers and p-aminophenyl ketone (described in U.S. Pat. No. 3,549,367), acridine and phenazine compounds (described in Japanese Unexamined Patent Publication (Kokai) syo No. 60-105667 and U.S. Pat. No. 4,239,850) and oxadiazole compounds (described in U.S. Pat. No. 4,212,970).

As the cationic-polymerization initiator, examples include organic sulfonium salts, iodonium salts, and phosphonium salts. As a counter ion of these compounds, an antimonate, a phosphate, or the like is preferably used.

The amount of the photo-polymerization initiators to be used is preferably 0.01 to 20% by weight, more preferably 0.5 to 5% by weight on the basis of solids in the coating liquid. Irradiation for polymerizing the liquid-crystalline molecules preferably uses UV rays. The irradiation energy is preferably 10 mJ/cm² to 10 J/cm², and more preferably 25 to 800 mJ/cm². The luminance is preferably 10 to 1000 mW/cm², more preferably 20 to 500 mW/cm², and still more preferably 40 to 350 mW/cm². It is preferred that the irradiation light to be used has a peak falling within the range from 250 to 450 nm, more preferred from 300 to 410 nm. Irradiation may be carried out in a nitrogen gas atmosphere and/or under heating to facilitate the photo-polymerization reaction.

### [Horizontal Orientation Agent]

At least one compound selected from the group consisting of the compounds represented by formula (1), (2) and (3) described in Japanese Unexamined Patent Publication (KOKAI) No. 2007-121986, paragraphs [0068] to [0072], and fluorine-containing homopolymer and copolymer using the monomer represented by the general formula (4), which are shown below, may be added to the composition used for forming the optically anisotropic layer, in order to promote aligning the liquid-crystalline molecules horizontally.

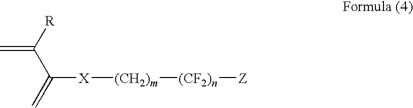

In the formula, R represents hydrogen atom or methyl group, X represents oxygen atom or sulfur atom, Z represents hydrogen atom or fluorine atom; m represents an integer of 1 to 6, n represents an integer of 1 to 12. The polymer compounds described in Japanese Unexamined Patent Publications (KOKAI) Nos. 2005-206638 and 2006-91205 can be used as horizontal orientation agents for reducing unevenness in coating. The method of preparation of the compounds is also described in the publications.

The amount of the horizontal orientation agents added is preferably from 0.01 to 20 weight %, more preferably from 0.01 to 10 weight % and much more preferably from 0.02 to 1 weight %. The compounds represented by the aforementioned general formula (1) to (4) may be used singly, or two or more types of them may be used in combination.

The aforementioned second optically anisotropic layer may an biaxial optically anisotropic layer that obtained in-plane retardation by photoinduced orientation with the aid of polarized light irradiation. When a rod-like liquid-crystalline compound is used to form a film exhibiting optical biaxiality, it is necessary to align rod-like molecules in a twisted cholesteric orientation, or in a twisted hybrid cholesteric orientation in which the tilt angles of the molecules are varied gradually in the thickness-direction, and then to distort the twisted cholesteric orientation or the twisted hybrid cholesteric orientation by irradiation of polarized light. Examples of the method for distorting the orientation by the polarized light irradiation include a method of using a dichroic liquid-crystalline polymerization initiator (EP1389199A1), and a method of using a rod-like liquid-crystalline compound having in the molecule thereof a photo-alignable functional group such as cinnamoyl group (Japanese Unexamined Patent Publication (KOKAI) No. 2002-6138).

The polarized light irradiation may be carried out at the same time with photo-polymerization process in the fixation of orientation, or the polarized light irradiation may precede and then may be followed by non-polarized light irradiation for further fixation, or the non-polarized light irradiation for fixation may precede and the polarized light irradiation may succeed for the photoinduced orientation. For the purpose of obtaining a large retardation, it is preferable to carry out only the polarized light irradiation, or to carry out the polarized light irradiation first preferably after coating and alignment of the layer comprising the liquid crystalline molecules. The polarized light irradiation is preferably carried out under an inert gas atmosphere having an oxygen concentration of 0.5% or below.

After the first irradiation of polarized light for photoinduced orientation, the optically anisotropic layer may be irradiated with polarized or non-polarized light so as to improve the reaction rate (post-curing step). As a result, the adhesiveness is improved and, thus, the optically anisotropic layer can be produced with larger feeding speed. The post-curing step may be carried out with polarized or non-polarized light, and preferably with polarized light. Two or more steps of post-curing are preferably carried out with only polarized light, with only non-polarized light or with combination of polarizing and non-polarized light. When polarized and non-polarized light are combined, irradiating with polarized light previous to irradiating with non-polarized light is preferred. The irradiation of UV light may be carried out under an inert gas atmosphere, and preferably under an inert gas atmosphere where the oxygen gas concentration is 0.5% or below.

### [The Liquid-Crystal Display Device]

The substrate for liquid crystal display device of the present invention can be employed as either of the two substrate for liquid crystal display devices forming a liquid crystal cell in a liquid-crystal display device, but is preferably employed as the substrate for liquid crystal display device opposite the substrate for liquid crystal display device on the side having the TFT layer, since the step for forming a TFT array needs a process of high-temperature higher than 300° C. for silicon formation. When employed as the substrate for liquid crystal display device on the side having the TFT layer, it is preferable to provide a smoothing layer functioning as both an alignment layer and an optically anisotropic layer on the substrate already having the silicon layer of the TFT, as well as other optically anisotropic layers.

Since an optically anisotropic layer can be provided in a liquid-crystal cell by means of the substrate for liquid crystal display device of the present invention, and is securely held by the glass substrate, there is less tendency for corner blurring to occur than when an optically anisotropic film the dimensions of which tend to change with temperature and humidity is bonded.

A smoothing layer having optical anisotropy and a second optically anisotropic layer can be employed to provide a liquid-crystal display device with an enlarged viewing angle. Retardation plates (optical compensation sheets) for TN mode liquid-crystal cells are described in the specifications of Japanese Unexamined Patent Publication (KOKAI) Heisei No. 6-214116; U.S. Pat. Nos. 5,583,679 and 5,646,703; and German Patent 3,911,620A1. Retardation plates (optical compensation sheets) for IPS mode and FLC mode liquid-crystal cells are described in the specification of Japanese Unexamined Patent Publication (KOKAI) Heisei No. 10-54982. Retardation plates (optical compensation sheets) for OCB mode and HAN mode liquid-crystal cells are described in the specifications of U.S. Pat. No. 5,805,253 and International Publication WO96/37804. Retardation plates (optical compensation sheets) for STN mode liquid-crystal cells are described in the specification of Japanese Unexamined Patent Publication (KOKAI) Heisei No. 9-26572. And retardation plates (optical compensation sheets) for VA mode liquid-crystal cells are described in the specification of Japanese Patent No. 2,866,372.

The substrate for liquid crystal display device of the present invention can be employed in liquid-crystal display devices of a variety of display modes, such as TN, IPS, FLC, OCB, STN, VA, and HAN modes. Of these, the substrate for liquid crystal display device of the present invention is particularly suited to VA mode liquid-crystal display devices.

The substrate for liquid crystal display device of the present invention preferably comprises a layer functioning as a negative c-plate and a layer functioning as a positive a-plate. Application to a liquid-crystal display device in which the orientation mode of the liquid-crystal layer is VA mode is preferable because it contributes to improving contrast viewing angle characteristics. It is preferable layer that the smoothing layer functions as a negative c-plate and the second optically anisotropic layer functions as a positive a-plate.

### EXAMPLES

The present invention is described in greater detail below through examples. The materials, reagents, weight quantities, proportions, operations, and the like that are given in the Examples below can be suitably modified without departing from the spirit of the present invention. Accordingly, the scope of the present invention is not limited to the specific examples given below.

### (Preparation of Smoothing Layer Coating Liquid SM-1)

The composition recorded below was prepared and filtered through a polypropylene filter having a pore size of 0.2 μm to obtain coating liquid SM-1 for smoothing layer.

Composition of coating liquid SM-1 for smoothing layer (%)

| | |
|---|---|
| Polyimide (SM-1-1) | 10.00 |
| Methyl ethyl ketone | 90.00 |

| | |
|---|---|
| | (SM-1-1) |
| 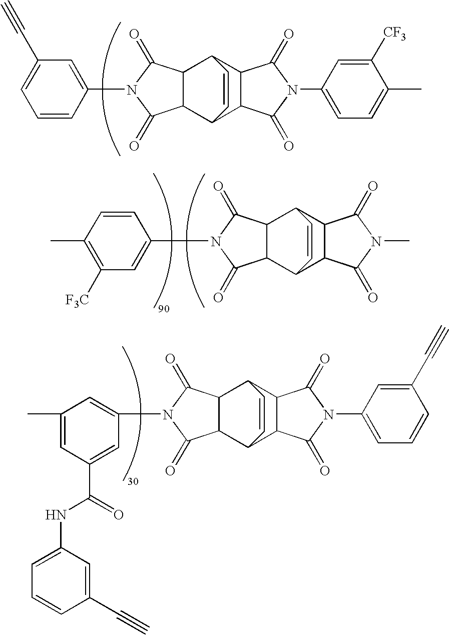 | |

### (Preparation of Coating Liquid LC-1 for Optically Anisotropic Layer)

The composition recorded below was prepared and filtered through a polypropylene filter having a pore size of 0.2 μm to obtain coating liquid LC-1 for optically anisotropic layer.

Composition of coating liquid LC-1 for optically anisotropic layer (%)

| | |
|---|---|
| Rod-like liquid crystals | 19.12 |
| (Paliocolor LC242, made by BASF Japan) | |
| Radical photopolymerization initiator | 0.60 |
| (Irgacure 907, made by Ciba Specialty Chemicals) | |
| Sensitizing agent | 0.20 |
| (Kayacure DETX, made by Nippon Kayaku Co., Ltd.) | |
| Horizontal orientation agent | 0.08 |
| (Megafac F-780F, made by DIC Co., Ltd.) | |
| Methyl ethyl ketone | 80.00 |

### (Preparation of Color Filter Substrate)

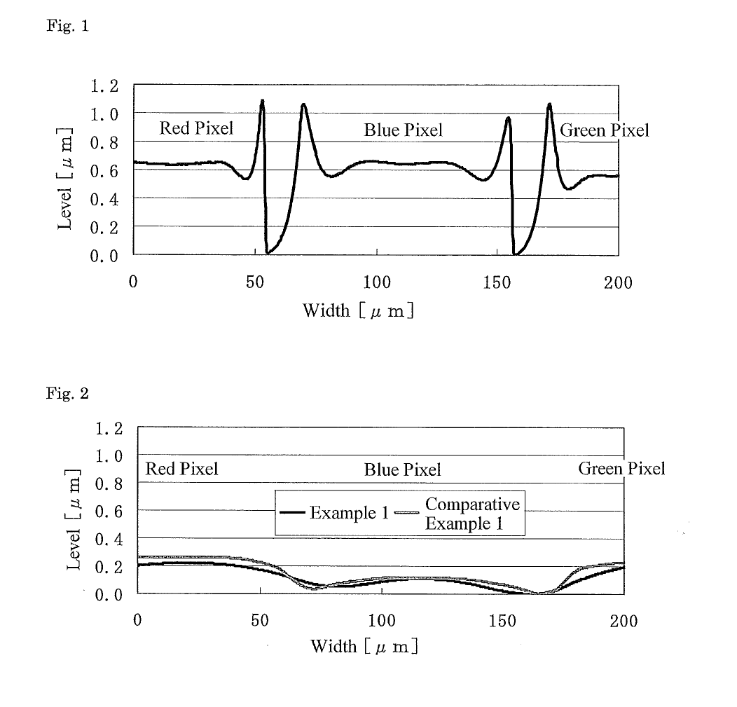

A color filter substrate having a black matrix and three (RGB) color filters on a glass substrate was prepared using the transfer system (made by Fuji Photo Film Co., Ltd.) described on page 25 of Fujifilm Research & Development No. 44 (1999). The irregular differences in level of this color filter substrate were measured using a VN-8000 nanoscale hybrid microscope (made by Keyence Corp.). Based on the irregular difference in level measurement results given in FIG. 1, a maximum irregular difference in level of about 1.1 μm was found to be present in the RGB pixels.

### Formation of the Smoothing Layer

### Example 1

Coating liquid SM-1 for the smoothing layer was applied on the above color filter substrate, dried, and baked for one hour at 230° C. to prepare the substrate for liquid crystal display device of Example 1. The film thickness of the smoothing layer following baking was 6.3 μm.

### Comparative Example 1

Negative photosensitive resin material coating liquid (Optomer SS-6688, made by JSR (Ltd.)) was applied on the above color filter substrate, dried, and baked for one hour at 230° C. Subsequently, polyimide material coating liquid (RN-1199A, made by Nissan Chemical Industries, Ltd.) was applied, dried, and baked for one hour at 230° C. to prepare the substrate for liquid crystal display device of Comparative Example 1. The film thickness of the smoothing layer following baking was 6.3 μm.

### (Measurement of Irregular Differences in Level)

The irregular differences in level of the surfaces of the substrate for liquid crystal display devices of Examples 1 and 2 and Comparative Example 1 were measured with a VN-8000 nanoscale hybrid microscope (made by Keyence Corp.). The irregular difference in level measurement results are given in FIG. 2, and the evaluation results are given in Table 1. Based on the results of Table 1, the irregular differences in level were 0.3 μm or less, demonstrating that the layer functioned as a smoothing layer.

TABLE 1

| Sample | Irregular difference in level |
|---|---|
| Example 1 | 0.2 μm |
| Comparative Example 1 | 0.3 μm |

### Formation of an Optically Anisotropic Layer

### Example 2

The substrate for liquid crystal display device of Example 1 was subjected to a rubbing process. On the rubbed surface coating liquid LC-1 for optically anisotropic layer was applied, and the coating was dried for 2 minutes at a film surface temperature of 105° C. to obtain a liquid-crystal phase. The coating was then irradiated with UV radiation in air with a 160 W/cm air-cooled metal halide lamp (made by Eye Graphics Co., Ltd.) at a power density of 240 mW/cm² and a dose of 600 mJ/cm² to fix the orientation, yielding the substrate for liquid crystal display device of Example 2. The film thickness of the optically anisotropic layer was 1.2 μm.

### Comparative Example 2

Next, with the exception that the substrate for liquid crystal display device of Comparative Example 1 was employed, the substrate for liquid crystal display device of Comparative Example 2 was obtained by the same method as that in Example 2. The film thickness of the optically anisotropic layer was 1.2 μm.

### (Evaluation of Light Leakage of the Optically Anisotropic Layer)

The substrate for liquid crystal display devices of Example 2 and Comparative Example 2 were evaluated by observation by polarizing microscopy. The observation was conducted with the polarizing plate of the polarizing microscope in a cross-nicol configuration and the substrate for liquid crystal display device aligned with the axis of extinction. The evaluation results are given in Table 2.

TABLE 2

| Sample | Evaluation result |
|---|---|
| Example 2 | No marked light leakage observed |
| Comparative Example 2 | No marked light leakage observed |

### Preparation of a Substrate for Retardation Measurement

### Example 3

The retardation of the smoothing layer was not measured on a color filter substrate, but instead using smoothing layer formed on a glass substrate by the same method as used in each example.

A non-alkali glass substrate was washed with a rotating brush having nylon bristles while spraying for 20 seconds a glass cleaning solution adjusted to 25° C., washed with a spray of pure water, and heated with a substrate preheating device for 2 minutes at 100° C. Subsequently, the substrate for retardation measurement of Example 3 was formed on this glass substrate by the same method as that used to form the smoothing layer in Example 1.

### Comparative Example 3

Next, the substrate for retardation measurement of Comparative Example 3 was formed by the same method as in Example 3, with the exception that the smoothing layer of Comparative Example 1 was formed.

### Example 4

A non-alkali glass substrate was washed with a rotating brush having nylon bristles while spraying for 20 seconds a glass cleaning solution adjusted to 25° C., washed with a spray of pure water, and heated with a substrate preheating device for 2 minutes at 100° C. Subsequently, polyimide material coating liquid (RN-1199A, made by Nissan Chemical Industries, Ltd.) was coated and dried, and the product was baked for 1 hour at 230° C. With the exception that the substrate prepared as above was employed, coating liquid LC-1 for optically anisotropic layer was used to provide an optically anisotropic layer by the same method as in Example 2 to obtain the substrate for retardation measurement of Example 4. The film thickness of the optically anisotropic layer was 1.2 μm.

### (Retardation Measurement)

The front retardation Re (0) and the retardation Re (40) and Re (−40) with the sample inclined by ±40° with the retardation axis (slow axis) as axis of rotation were measured at a wavelength of 550 nm by the parallel Nicol method employing a fiber spectrometer. The results of retardation measurement of the substrate for retardation measurement of Example 3, substrate for retardation measurement of Comparative Example 3, and substrate for retardation measurement of Example 4 are given in Table 3.

TABLE 3

| Sample | Re(0) | | Re(40) | | Re(−40) | |
|---|---|---|---|---|---|---|
| Example 3 | 0.1 | nm | 30.0 | nm | 30.5 | nm |
| Comparative | 0.2 | nm | 0.2 | nm | 0.3 | nm |
| Example 3 | | | | | | |
| Example 4 | 135.8 | nm | 143.2 | nm | 145.8 | nm |

### Fabrication of a VA Mode Liquid-Crystal Display Device

### Example 5

Transparent electrode films were formed by sputtering ITO on the substrate for liquid crystal display device of Example 3 and an opposing substrate in the form of a glass substrate on which a TFT layer had been provided. A polyimide alignment layer was provided thereover. A sealing agent of epoxy resin containing spacer particles was printed at a position corresponding to the frame of the black matrix provided around groups of color filter pixels, and the substrate for liquid crystal display device of Example 2 and the opposite substrate were bonded together at a pressure of 10 kg/cm. Next, a heat treatment was conducted for 90 minutes at 150° C. to cure the sealing agent, yielding a laminate of two glass substrates. The air was evacuated under vacuum from the glass substrate laminate. The glass substrate laminate was then placed in the atmosphere again and liquid crystals were filled into the gap between the two glass substrates to obtain a VA mode liquid-crystal cell. HLC2-2518 polarizing plates made by Sanritz (Ltd.) were bonded to the two surfaces of the VA mode liquid-crystal cell. A cold cathode tube backlight for a liquid-crystal display device in the form of a white three-wavelength fluorescent lamp of adjustable color was fabricated by mixing 50:50 weight ratios of phosphors in the form of BaMg₂Al₁₆O₂₇:Eu and Mn, and LaPO₄:Ce and Tb, as green (G); employing Y₂O₃:Eu as red (R); and employing BaMgAl₁₀O₁₇:Eu as blue (B). A VA mode liquid-crystal cell equipped with the polarizing plates was positioned on the above backlight to obtain the VA mode liquid-crystal display device of Example 5.

### Comparative Example 4

With the exception that the substrate for liquid crystal display device of Comparative Example 2 was employed, the VA mode liquid-crystal display device of Comparative Example 4 was obtained by the same method as that in Example 5.

### (Visual Evaluation of the VA Mode Liquid-Crystal Display Devices)

The results of visual evaluation of Example 5 and Comparative Example 4 are given in Table 4.

TABLE 4

| Sample | Visual evaluation results |
|---|---|
| Example 5 | Good contrast viewing angle characteristics, no |
| | noticeable color blurring during black display |
| Comparative | Poor contrast viewing angle characteristics, |
| Example 4 | noticeable color blurring during black display |

### EFFECT OF INVENTION

The present invention provides a substrate for liquid crystal display device that reduces the number of manufacturing steps in the form of a liquid-crystal device substrate comprising a layer simultaneously functioning as a smoothing layer and an optically anisotropic layer, or simultaneously functioning as a smoothing layer, an alignment layer, and an optically anisotropic layer.

1. A substrate for liquid crystal display device comprising a layer having irregular differences in level and a smoothing layer provided directly on the layer having irregular differences in level, wherein the thickness of the smoothing layer is greater than the irregular differences in level, and the in-plane retardation of the layer inclined of 40° with the retardation axis as the axis of rotation is 5 to 150 nm.

2. The substrate for liquid crystal display device according to claim 1, wherein a second optically anisotropic layer is provided directly on an orientation-processed surface of the smoothing layer.

3. The substrate for liquid crystal display device according to claim 2, wherein the orientation process is selected from the group consisting of rubbing, optical orientation, extension, and contraction.

4. The substrate for liquid crystal display device according to claim 2, wherein the second optically anisotropic layer is an optically anisotropic layer having a positive uniaxial or diaxial property with an optical axis in an in-plane direction of the substrate.

5. The substrate for liquid crystal display device according to claim 2, wherein the in-plane retardation of the second optically anisotropic layer is 40 to 550 nm.

6. The substrate for liquid crystal display device according to claim 2, wherein the second optically anisotropic layer is a layer that is formed by applying and drying a solution comprising a liquid-crystalline compound having at least one reactive group to form a liquid-crystal phase, followed by heating or irradiation with light.

7. The substrate for liquid crystal display device according to claim 6, wherein the liquid-crystalline compound is a rod-like liquid-crystalline compound.

8. The substrate for liquid crystal display device according to claim 1, wherein the pitch of the irregularities is 10-fold or greater the irregular differences in level.

9. The substrate for liquid crystal display device according to claim 1, wherein the layer having irregular differences in level is a color filter layer or a layer in which TFT is formed.

10. The substrate for liquid crystal display device according to claim 1, wherein the smoothing layer is formed by applying and drying a solution comprising a compound having at least one reactive group, followed by heating or irradiation with light.

11. The substrate for liquid crystal display device according to claim 10, wherein the compound having a reactive group comprises a least one polymerizable group selected from the group consisting of an acetylene group, maleimide group, nadiimide group, benzoxazine group, vinyl group, epoxy group, cyanate group, and isocyanate group.

12. The substrate for liquid crystal display device according to claim 1, wherein the smoothing layer is a layer comprising at least one selected from the group consisting of polyimide, polyisoimide, polyesterimide, polyetherimide, polyamide-imide, polyamide acid, polyamide acid ester, polyamide, polyamine, polythioamide, polyurethane, polyurea, and polyazomethine.

13. The substrate for liquid crystal display device according to claim 1, wherein the absorbance at 400 nm wavelength of the smoothing layer is 0.2 or lower.

14. The substrate for liquid crystal display device according to claim 1, wherein the smoothing layer has negative uniaxial optical anisotropy with an optical axis that is substantially normal to the surface.

15. A liquid-crystal display device comprising the substrate for liquid crystal display device of claim 1.

16. The liquid-crystal display device of claim 15, wherein the orientation mode of the liquid-crystal display device is VA mode.

17. A composition for producing a smoothing layer of a substrate for liquid crystal display device, comprising a copolymer having the repeating unit represented by general formula (1) and the repeating unit represented by general formula (2) as follows: 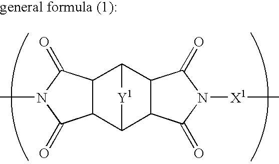
in general formula (1), Y¹ represents methylene group, ethylene group, or ethenylene group, and X¹ represents a divalent linking group represented by general formula (3) below; 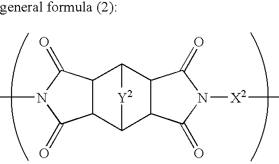
in general formula (2), Y² represents methylene group, ethylene group, or ethenylene group, and X² represents a divalent linking group represented by general formula (4) below; 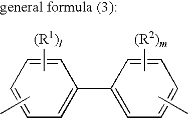
in general formula (3), each of R¹ and R² independently represents a group selected from the group consisting of a halogen atom, a substituted or unsubstituted alkyl group, a substituted or unsubstituted alkoxy group, and a substituted or unsubstituted aryl group, and each of l and m independently represents an integer of 0 to 4; 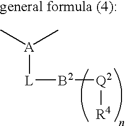
in general formula (4), A represents an unsubstituted or optionally substituted cyclic or acyclic hydrocarbon group, with A not comprising a partial structure in which three or more aromatic rings are directly linked by a single carbon atom; B² represents a substituted or unsubstituted aryl group or a heteroaryl group; L represents a divalent linking group; Q² represents a reactive group; R⁴ represents hydrogen atom, unsubstituted or optionally substituted cyclic or acyclic hydrocarbon group; and n represents an integer of 0 or greater.

18. The composition according to claim 17, wherein the terminals of the copolymer are sealed with a compound represented by general formula (5) as follows: 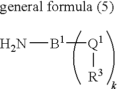
in general formula (5), B¹ represents a substituted or unsubstituted aryl group or a heteroaryl group; Q¹ represents a reactive group; R³ represents hydrogen atom or an unsubstituted or optionally substituted cyclic or acyclic hydrocarbon group; and k represents an integer of 0 or greater.
